(19) United States
(12) Patent Application Publication
(10) Pub. No.: US 2019/0072165 A1
(43) Pub. Date: Mar. 7, 2019

(54) TORSIONAL VIBRATION DAMPER WITH MULTI-PIECE RADIALLY ELASTIC OUTPUT MEMBER, AND METHOD FOR MAKING THE SAME

(71) Applicant: Valeo Embrayages, Amiens Cedex (FR)

(72) Inventors: Xuexian YIN, Troy, MI (US); Antoine CANTENOT, Troy, MI (US); Patrick DURHAM, Troy, MI (US)

(21) Appl. No.: 15/697,201

(22) Filed: Sep. 6, 2017

(51) Int. Cl. F16H 45/02; F16F 15/12

(52) U.S. Cl. CPC F16H 45/02; F16H 2045/002; F16F 15/12

(57) ABSTRACT

A torsional vibration damper of a hydrokinetic torque-coupling device. The torsional vibration damper comprises an input member including a first side plate and a supporting member mounted to the first side plate, and a radially elastic member elastically coupled to the input member. The radially elastic member includes a central part and an elastic blade formed separately from the central part. The central part has a mounting portion. The elastic blade has a connection portion, a free distal end and a curved raceway portion disposed between the connection portion and the distal end. The connection portion of the elastic blade is non-rotatably connected to the mounting portion of the central part. The curved raceway portion of the elastic blade is configured to elastically engage the supporting member and to elastically bend in the radial direction upon rotation of the input member with respect to the radially elastic member.

### BACKGROUND OF THE INVENTION

### 1. Field of the Invention

The present invention generally relates to fluid coupling devices, and more particularly to a torsional vibration damper for hydrokinetic torque-coupling devices with a multi-piece radially elastic output member, and a method for making the same.

### 2. Background of the Invention

A conventional hydrokinetic torque-coupling device 1 is schematically and partially illustrated in FIG. 1 and is configured to transmit torque from an output shaft of an internal combustion engine in a motor vehicle, such as for instance a crankshaft 2a, to a transmission input shaft 2b. The conventional hydrokinetic torque-coupling device comprises a hydrokinetic torque converter 4 and a torsional vibration damper 5. The hydrokinetic torque converter conventionally comprises an impeller wheel 4i, a turbine wheel 4t, a stator (or reactor) 4s fixed to a casing of the torque converter 4, and a one-way clutch for restricting rotational direction of the stator 8 to one direction. The impeller wheel 4i is configured to hydro-kinetically drive the turbine wheel 4t through the reactor 4s. The impeller wheel 4i is coupled to the crankshaft 1 and the turbine wheel 4t is coupled to a guide washer 6.

The torsional vibration damper 5 of the compression spring type comprises a first group of coil springs 7a, 7b mounted between the guide washer 6 and an output hub 8 coupled to the transmission input shaft 2b. The coil springs 7a, 7b of the first group are arranged in series through a phasing member 9, so that the coil springs 7a, 7b are deformed in phase with each other, with the phasing member 9 being movable relative to the guiding washer 6 and relative to the output hub 8. A second group of coil springs 7c is mounted with some clearance between the guide washer 6 and the output hub 8 in parallel with the first group of elastic members 7a, 7b, with the coil springs 7c being adapted to be active on a limited angular range, more particularly at the end of the angular travel of the guide washer 6 relative to the output hub 8. The angular travel, or the angular shift noted α, of the guide washer 6 relative to the output hub 8, is defined relative to a rest position (α=0) wherein no torque is transmitted through damping means formed by the coil springs 7a, 7b. The second group of coil springs 7c makes it possible to increase the stiffness of the damping means at the end of angular travel, i.e. for a significant a angular offset of the guide washer 6 relative to the output hub 8 (or vice versa).

The torque-coupling device 1 further comprises a lock-up clutch 3 adapted to transmit torque from the crankshaft 2a to the guide washer 6 in a determined operation phase, without action from the impeller wheel 4i and the turbine wheel 4t.

The turbine wheel 4t is integrally or operatively connected with the output hub 8 linked in rotation to a driven shaft, which is itself linked to an input shaft of a transmission of a vehicle. The casing of the torque converter 4 generally includes a front cover and an impeller shell which together define a fluid filled chamber. Impeller blades are fixed to an impeller shell within the fluid filled chamber to define the impeller assembly. The turbine wheel 4t and the stator 4s are also disposed within the chamber, with both the turbine wheel 4t and the stator 4s being relatively rotatable with respect to the front cover and the impeller wheel 4i. The turbine wheel 4t includes a turbine shell with a plurality of turbine blades fixed to one side of the turbine shell facing the impeller blades of the impeller wheel 4i.

The turbine wheel 4t works together with the impeller wheel 4i, which is linked in rotation to the casing that is linked in rotation to a driving shaft driven by an internal combustion engine. The stator 4s is interposed axially between the turbine wheel 4t and the impeller wheel 4i, and is mounted so as to rotate on the driven shaft with the interposition of the one-way clutch.

While conventional hydrokinetic torque-coupling devices, including but not limited to those discussed above, have proven to be acceptable for vehicular driveline applications and conditions, improvements that may enhance their performance and cost are possible.

### BRIEF SUMMARY OF THE INVENTION

According to a first aspect of the invention, there is provided a torsional vibration damper of a hydrokinetic torque-coupling device for coupling a driving shaft and a driven shaft together. The torsional vibration damper comprises a torque input member including a radially oriented first side plate and at least one supporting member mounted to the first side plate, and a radially elastic member elastically coupled to the torque input member. The radially elastic member includes a central part and at least one curved elastic blade formed separately from the central part. The central part is coaxial with the rotational axis and rotatable relative the torque input member. The central part has a mounting portion. The at least one curved elastic blade has a connection portion, a free distal end and a curved raceway portion disposed between the connection portion and the free distal end of the at least one elastic blade for bearing the at least one supporting member. The connection portion of the at least one curved elastic blade is non-rotatably connected to the mounting portion of the central part. The curved raceway portion of the at least one curved elastic blade is configured to elastically and radially engage the at least one supporting member and to elastically bend in the radial direction upon rotation of the torque input member with respect to the radially elastic member.

According to a second aspect of the invention, there is provided a hydrokinetic torque-coupling device for coupling a driving shaft and a driven shaft together. The torque-coupling device comprises a casing rotatable about a rotational axis and having a locking surface, a torque converter including an impeller wheel rotatable about the rotational axis and a turbine wheel disposed in the casing coaxially with the rotational axis, a lock-up clutch including a locking piston axially moveable along the rotational axis to and from the locking surface of the casing, and a torsional vibration damper. The turbine wheel is disposed axially opposite to the impeller wheel and hydro-dynamically rotationally drivable by the impeller wheel. The locking piston has an engagement surface configured to selectively frictionally engage the locking surface of the casing to position the hydrokinetic torque-coupling device into and out of a lockup mode in which the locking piston is mechanically frictionally locked to the casing so as to be non-rotatable relative to the casing. The torsional vibration damper comprises a torque input member including a radially oriented first side plate and at least one supporting member mounted to the first side plate, and a radially elastic member elastically coupled to the torque input member. The first side plate is non-rotatably coupled to the locking piston. The radially elastic member includes a central part and at least one curved elastic blade formed separately from the central part. The central part is coaxial with the rotational axis and rotatable relative the torque input member. Also, the central part has a mounting portion. The at least one curved elastic blade has a connection portion, a free distal end and a curved raceway portion disposed between the connection portion and the free distal end of the at least one elastic blade for bearing the at least one supporting member. The connection portion of the at least one curved elastic blade is non-rotatably connected to the mounting portion of the central part. The curved raceway portion of the at least one curved elastic blade is configured to elastically and radially engage the at least one supporting member and to elastically bend in the radial direction upon rotation of the torque input member with respect to the radially elastic member.

According to a third aspect of the present invention, there is provided a method for assembling a torsional vibration damper of a hydrokinetic torque-coupling device for coupling a driving shaft and a driven shaft together. The method involves the steps of providing a torque input member including a radially oriented first side plate and at least one supporting member mounted to the first side plate, and providing a radially elastic member including a central part and at least one curved elastic blade formed separately from the central part. The central part has a mounting portion. The at least one curved elastic blade has a connection portion, a free distal end and a curved raceway portion disposed between the connection portion and the free distal end of the at least one elastic blade. The method further involves the steps of non-rotatably connecting the connection portion of the at least one curved elastic blade to the mounting portion of the central part to define the radially elastic member, and mounting the assembled radially elastic member to the torque input member so that the curved raceway portion of the at least one curved elastic blade elastically and radially engages the at least one supporting member, the curved raceway portion of the at least one curved elastic blade configured to elastically bend in the radial direction upon rotation of the torque input member with respect to the radially elastic member.

Other aspects of the invention, including apparatus, devices, systems, converters, processes, and the like which constitute part of the invention, will become more apparent upon reading the following detailed description of the exemplary embodiments.

### BRIEF DESCRIPTION OF THE SEVERAL VIEWS OF THE DRAWING(S)

The accompanying drawings are incorporated in and constitute a part of the specification. The drawings, together with the general description given above and the detailed description of the exemplary embodiments and methods given below, serve to explain the principles of the invention. The objects and advantages of the invention will become apparent from a study of the following specification when viewed in light of the accompanying drawings, in which like elements are given the same or analogous reference numerals and wherein:

FIG. 1 is a schematic representation of a torque-coupling device of the prior art;

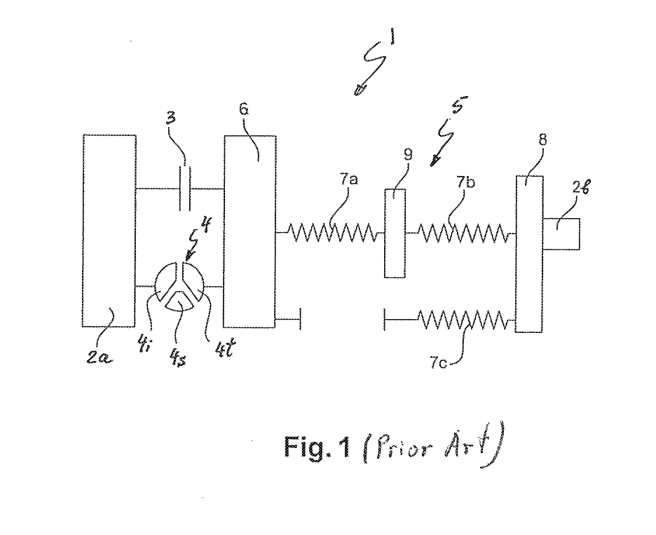

FIG. 2 is a fragmented half-view in axial section of a hydrokinetic torque-coupling device with a torsional vibration damper in accordance with exemplary embodiments of the present invention;

FIG. 3A is fragmented partial half-view in axial section of the hydrokinetic torque-coupling device showing the lock-up clutch and the torsional vibration damper in accordance with the exemplary embodiments of the present invention;

FIG. 3B is a partial perspective view of the hydrokinetic torque-coupling device showing the locking piston and the torsional vibration damper in accordance with the exemplary embodiments of the present invention;

FIG. 4 is a perspective view of the torsional vibration damper in accordance with the exemplary embodiments of the present invention;

FIG. 5 is an exploded perspective view of the torsional vibration damper in accordance with a first exemplary embodiment of the present invention;

FIG. 6A is a partial front view of a torque input member and a radially elastic output member of the torsional vibration damper in accordance with the first exemplary embodiment of the present invention;

FIG. 6B is a front view of the radially elastic output member of the torsional vibration damper in accordance with the first exemplary embodiment of the present invention;

FIG. 6C is a cross-sectional view of the radially elastic output member in accordance with the first exemplary embodiment thereof taken along the line 6C-6C in FIG. 6B;

FIG. 7 is an exploded perspective view of the torque input member and the radially elastic output member of the of the torsional vibration damper in accordance with the first exemplary embodiment of the present invention;

FIG. 8 is an exploded perspective view of a central part and curved elastic blades of the radially elastic output member of the of the torsional vibration damper in accordance with the first exemplary embodiment of the present invention;

FIG. 9A is a front view of a curved elastic blade of the radially elastic output member in accordance with the first exemplary embodiment of the present invention;

FIG. 9B is a cross-sectional view of the curved elastic blade of the radially elastic output member taken along the line 9B-9B in FIG. 9A;

FIG. 10A is a front view of a core member of the radially elastic output member in accordance with the first exemplary embodiment of the present invention;

FIG. 10B is a cross-sectional view of the core member of the radially elastic output member taken along the line 10B-10B in FIG. 10A;

FIG. 11 is a side view of the radially elastic output member of the torsional vibration damper in accordance with the first exemplary embodiment of the present invention;

FIG. 12 is an exploded perspective view of the torsional vibration damper in accordance with a second exemplary embodiment of the present invention;

FIG. 13 is an exploded perspective view of the torque input member and the radially elastic output member of the of the torsional vibration damper in accordance with the second exemplary embodiment of the present invention;

FIG. 14A is a partial front view of a torque input member and a radially elastic output member of the torsional vibration damper in accordance with the second exemplary embodiment of the present invention;

FIG. 14B is a front view of the radially elastic output member of the torsional vibration damper in accordance with the second exemplary embodiment of the present invention;

FIG. 15 is an exploded perspective view of a central part and curved elastic blades of the radially elastic output member of the of the torsional vibration damper in accordance with the second exemplary embodiment of the present invention;

FIG. 16 is a front view of the curved elastic blade of the radially elastic output member of the of the torsional vibration damper in accordance with the second exemplary embodiment of the present invention;

FIG. 17 is a front view of the central part of the radially elastic output member of the of the torsional vibration damper in accordance with the second exemplary embodiment of the present invention;

FIG. 18 is an exploded perspective view of the torsional vibration damper in accordance with a third exemplary embodiment of the present invention;

FIG. 19 is an exploded perspective view of the torque input member and the radially elastic output member of the of the torsional vibration damper in accordance with the third exemplary embodiment of the present invention;

FIG. 20A is a partial front view of a torque input member and a radially elastic output member of the torsional vibration damper in accordance with the third exemplary embodiment of the present invention;

FIG. 20B is a front view of the radially elastic output member of the torsional vibration damper in accordance with the third exemplary embodiment of the present invention;

FIG. 21 is an exploded perspective view of a central part and curved elastic blades of the radially elastic output member of the of the torsional vibration damper in accordance with the third exemplary embodiment of the present invention;

FIG. 22 is a front view of the curved elastic blade of the radially elastic output member of the of the torsional vibration damper in accordance with the third exemplary embodiment of the present invention;

FIG. 23 is a front view of the central part of the radially elastic output member of the of the torsional vibration damper in accordance with the third exemplary embodiment of the present invention;

FIG. 24 is an exploded perspective view of the torsional vibration damper in accordance with a fourth exemplary embodiment of the present invention;

FIG. 25 is an exploded perspective view of the torque input member and the radially elastic output member of the of the torsional vibration damper in accordance with the fourth exemplary embodiment of the present invention;

FIG. 26A is a partial front view of a torque input member and a radially elastic output member of the torsional vibration damper in accordance with the fourth exemplary embodiment of the present invention;

FIG. 26B is a front view of the radially elastic output member of the torsional vibration damper in accordance with the fourth exemplary embodiment of the present invention;

FIG. 27 is an exploded perspective view of a central part and curved elastic blades of the radially elastic output member of the of the torsional vibration damper in accordance with the fourth exemplary embodiment of the present invention;

FIG. 28 is a front view of the curved elastic blade of the radially elastic output member of the of the torsional vibration damper in accordance with the fourth exemplary embodiment of the present invention; and

FIG. 29 is a front view of the central part of the radially elastic output member of the of the torsional vibration damper in accordance with the fourth exemplary embodiment of the present invention.

### DETAILED DESCRIPTION OF EXEMPLARY EMBODIMENT(S) AND EMBODIED METHOD(S) OF THE INVENTION

Reference will now be made in detail to exemplary embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in connection with the exemplary embodiments and methods.

This description of exemplary embodiments is intended to be read in connection with the accompanying drawings, which are to be considered part of the entire written description. In the description, relative terms such as “horizontal,” “vertical,” “up,” “down,” “upper”, “lower”, “right”, “left”, “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. The term “integral” (or “unitary”) relates to a part made as a single part, or a part made of separate components fixedly (i.e., non-moveably) connected together. Additionally, the word “a” and “an” as used in the claims means “at least one” and the word “two” as used in the claims means “at least two”.

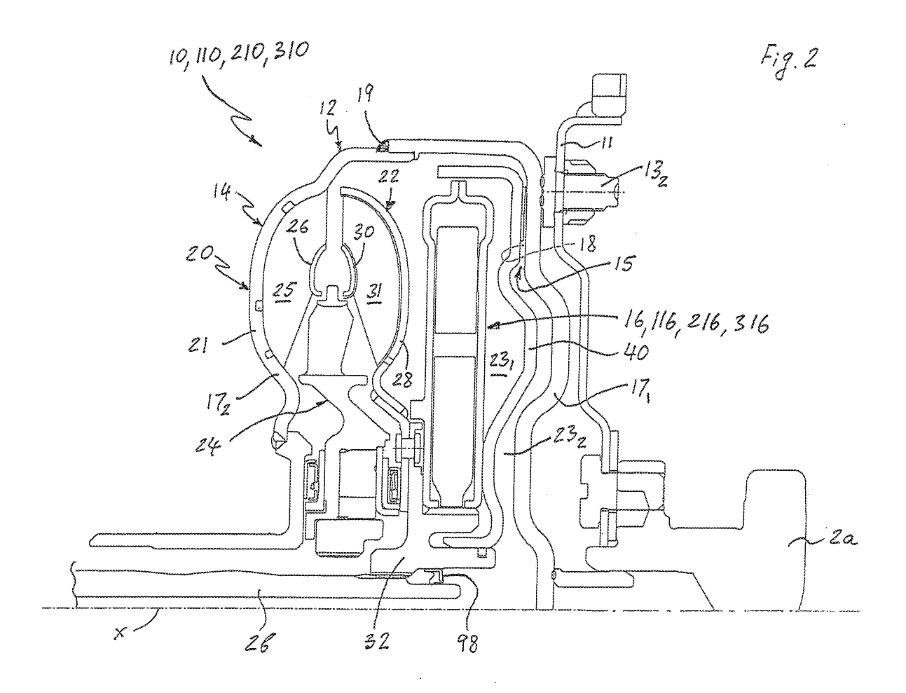

A first exemplary embodiment of a hydrokinetic torque-coupling device is generally represented in FIG. 2 by reference numeral 10. The hydrokinetic torque-coupling device 10 is intended to couple a driving shaft 2a and a driven shaft 2b, for example in a motor vehicle. In this case, the driving shaft 2a is an output shaft of an internal combustion engine (ICE) of the motor vehicle and the driven shaft 2b is a transmission input shaft of an automatic transmission of the motor vehicle.

The hydrokinetic torque-coupling device 10 comprises a sealed casing 12 filled with a fluid, such as oil or transmission fluid, and rotatable about a rotational axis X of rotation, a hydrokinetic torque converter 14 disposed in the casing 12, a lock-up clutch 15 and a torque transmitting device (or torsional vibration damper) 16 also disposed in the casing 12. The torsional vibration damper 16 of the present invention is in the form of a leaf (or blade) damper. The sealed casing 12, the torque converter 14, the lock-up clutch 15 and the torsional vibration damper 16 are all rotatable about the rotational axis X. The drawings discussed herein show half-views, that is, a cross-section of the portion or fragment of the hydrokinetic torque-coupling device 10 above the rotational axis X. As is known in the art, the torque-coupling device 10 is symmetrical about the rotational axis X. Hereinafter the axial and radial orientations are considered with respect to the rotational axis X of the torque-coupling device 10. The relative terms such as “axially,” “radially,” and “circumferentially” are with respect to orientations parallel to, perpendicular to, and circularly around the rotational axis X, respectively.

The sealed casing 12 according to the exemplary embodiment as illustrated in FIG. 2 includes a first shell (or casing shell) 17₁ and a second shell (or impeller shell) 17₂ disposed coaxially with each other. The first shell 17₁ and the second shell 17₂ are non-movably (i.e., fixedly) connected and sealed together about their outer peripheries, such as by a weld 19, as shown in FIG. 2. The first shell 17₁ is non-movably (i.e., fixedly) connected to the driving shaft, more typically to the output shaft of the ICE through a flexplate 11 that is non-rotatably fixed to the driving shaft 2a, so that the casing 12 turns at the same speed at which the engine operates for transmitting torque. Specifically, in the illustrated embodiment of FIG. 2, the casing 12 is rotatably driven by the ICE and is non-rotatably coupled to the driving shaft 2a, such as through the flexplate 11 and studs 13. Typically, the studs 13 are fixedly secured, such as by welding, to the first shell 17₁. Each of the first and second shells 17₁, 17₂ may be integral or one-piece and may be made, for example, by press-forming one-piece metal sheets.

The torque converter 14 comprises an impeller assembly (sometimes referred to as the pump or impeller wheel) 20, a turbine assembly (sometimes referred to as the turbine wheel) 22, and a stator (sometimes referred to as the reactor) 24 interposed axially between the impeller wheel 20 and the turbine wheel 22. The impeller wheel 20, the turbine wheel 22, and the stator 24 are coaxially aligned with one another and the rotational axis X. The impeller wheel 20, the turbine wheel 22, and the stator 24 collectively form a torus. The impeller wheel 20 and the turbine wheel 22 may be fluidly coupled to one another in operation as known in the art.

The impeller wheel 20 includes a substantially annular, semi-toroidal (or concave) impeller shell 21, a substantially annular impeller core ring 26, and a plurality of impeller blades 25 fixedly (i.e., non-moveably) attached, such as by brazing, to the impeller shell 21 and the impeller core ring 26. Thus, at least a portion of the second shell 17₂ of the casing 12 also forms and serves as the impeller shell 21 of the impeller assembly 20. Accordingly, the impeller shell 21 sometimes is referred to as part of the casing 12. The impeller wheel 20, including the impeller shell 21, the impeller core ring 26 and the impeller blades 25, are non-rotatably secured to the second shell 17₂ and hence to the driving shaft 2a (or flywheel) of the engine to rotate at the same speed as the engine output. The impeller shell 21, the impeller core ring 26 and the impeller blades 25 may be conventionally formed by stamping from steel blanks.

The turbine wheel 22, as best shown in FIG. 2, comprises a substantially annular, semi-toroidal (or concave) turbine shell 28 rotatable about the rotational axis X, a substantially annular turbine core ring 30, and a plurality of turbine blades 31 fixedly (i.e., non-moveably) attached, such as by brazing, to the turbine shell 28 and the turbine core ring 30. The turbine shell 28, the turbine core ring 30 and the turbine blades 31 may be conventionally formed by stamping from steel blanks.

The torque-coupling device 10 further includes an annular output hub (also referred to as a central hub) 32 rotatable about the rotational axis X. The output hub 32 is operatively coupled to and coaxial with the driven shaft. For example, according to the exemplary embodiment, the output hub 32 is provided with internal splines 33 for non-rotatably coupling the output hub 32 to the driven shaft 2b, such as a transmission input shaft, provided with complementary external splines or grooves. Alternatively, a weld or other connection may be used to fix the output hub 32 to the driven shaft 2b. A radially outer surface of the output hub 32 includes an annular slot 34 for receiving a sealing member, such as an O-ring 35. A sealing member 98, mounted to a radially inner peripheral surface of the output hub 32, creates a seal at the interface of the transmission input shaft 2b and the output hub 32, as best shown in FIG. 2.

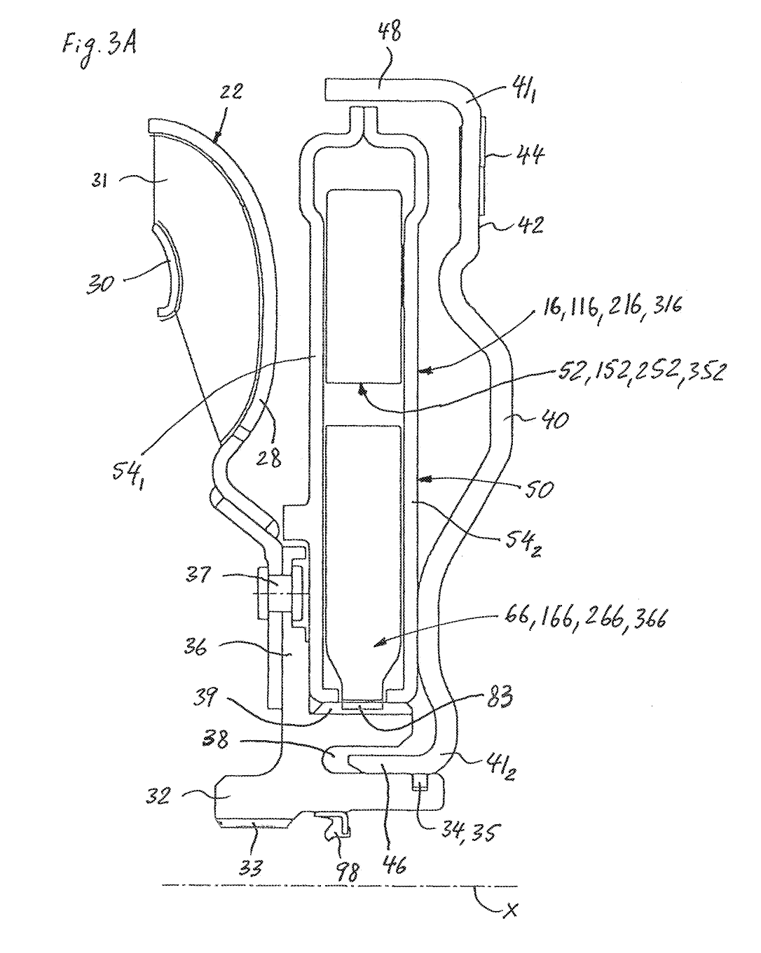

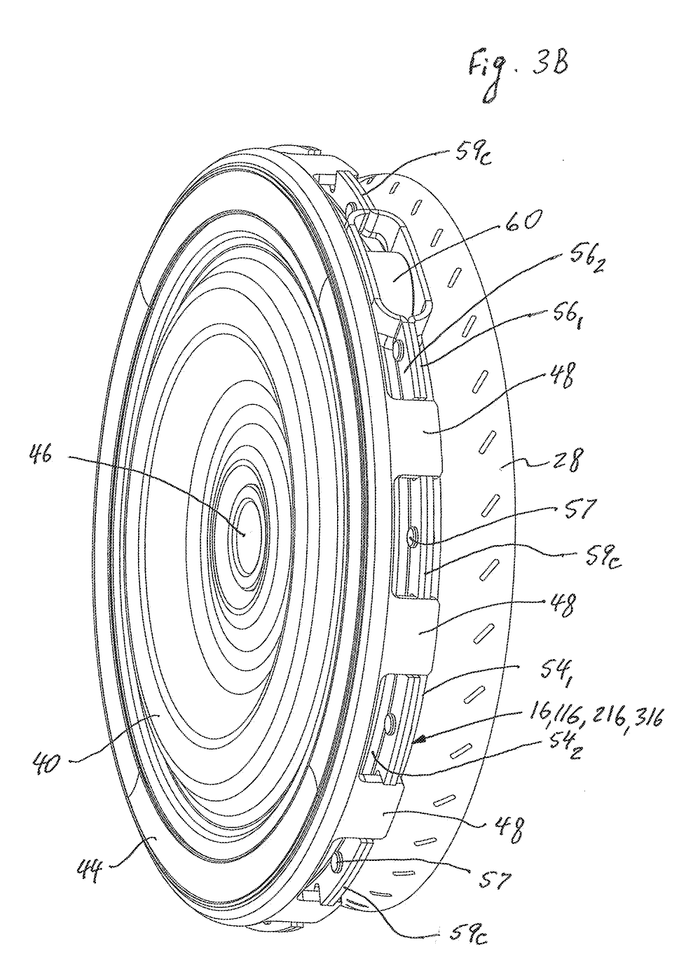

The central hub 32 has an annular flange 36 extending radially outwardly from the central hub 32, and an annular groove 38, which axially opens opposite the impeller wheel 20 and the turbine wheel 22, as best shown in FIG. 3A. The turbine shell 28 of the turbine wheel 22 is non-movably (i.e., fixedly) secured to the flange 36 of the output hub 32 by any appropriate means, such as by rivets 37 (best shown in FIG. 3A) or welding. Moreover, the output hub 32 is provided with external splines 39 for operatively coupling the output hub 32 to the torsional vibration damper 16.

The lock-up clutch 15 includes a substantially annular locking piston 40 having an engagement surface 42 facing a locking surface 18 defined on the first casing shell 17₁ of the casing 12. The locking piston 40 is axially moveable relative to the output hub 32 along the rotational axis X to and from the locking surface 18 so as to selectively engage the locking piston 40 against the locking surface 18 of the casing 12. The lock-up clutch 15 further includes an annular friction liner 44 fixedly attached to the engagement surface 42 of the locking piston 40 by appropriate means known in the art, such as by adhesive bonding. As best shown in FIGS. 2 and 3A, the friction liner 44 is fixedly attached to the engagement surface 42 of the locking piston 40 at a radially outer peripheral end 41₁ thereof.

The annular friction liner 44 is made of a friction material for improved frictional performance. Alternatively, the annular friction liner 44 may be secured to the locking surface 18 of the casing 12. According to still another embodiment, a first friction ring or liner is secured to the locking surface 18 of the casing 12 and a second friction ring or liner is secured to the engagement surface 42 of the locking piston 40. It is within the scope of the invention to omit one or both of the friction rings. In other words, the annular friction liner 44 may be secured to any, all, or none of the engagement surfaces. Further with the exemplary embodiment, the engagement surface 42 of the locking piston 40 is slightly conical to improve the engagement of the lock-up clutch 15. Specifically, the engagement surface 42 of the locking piston 40 holding the annular friction liner 44 is conical, preferably at an angle between 10° and 30°, to improve the torque capacity of the lock-up clutch 15. Alternatively, the engagement surface 42 of the locking piston 40 may be parallel to the locking surface 18 of the casing 12.

The lock-up clutch 15 is provided for locking the driving and driven shafts 2a, 2b. The lock-up clutch 15 is usually activated after starting of the motor vehicle and after hydraulic coupling of the driving and driven shafts, in order to avoid the loss of efficiency caused in particular by slip phenomena between the turbine wheel 20 and the impeller wheel 22. The locking piston 34 is axially displaceable toward (an engaged (or locked) position of the lock-up clutch 15) and away (a disengaged (or open) position of the lock-up clutch 15) from the locking surface 18 inside the casing 12. Moreover, the locking piston 34 is axially displaceable away from (the engaged (or locked) position of the lock-up clutch 15) and toward (the disengaged (or open) position of the lock-up clutch 15) the torsional vibration damper 16. Specifically, extending axially at a radially inner peripheral end 41₂ of the locking piston 40 is a cylindrical rim 46 that is proximate to and coaxial with the rotational axis X, as best shown in FIG. 3B. The locking piston 40 is mounted to the output hub 32 so that the cylindrical rim 46 of the locking piston 40 is disposed in the annular groove 38 of the output hub 32. Consequently, the locking piston 40 is centered and rotatable and axially slidably displaceable relative to the output hub 32 and about a radially internal cylindrical surface of the annular groove 38 of the output hub 32.

The sealing member (e.g., the sealing ring) 35 creates a seal at the interface of the cylindrical rim 46 of the locking piston 40 and the output hub 32. As discussed in further detail below, the locking piston 40 is axially movably relative to the output hub 32 along this interface. The axial motion of the locking piston 40 along the output hub 32 is controlled by first and second pressure chambers 23₁, 23₂ positioned on axially opposite sides of the locking piston 40.

The locking piston 40 is selectively pressed against the locking surface 18 of the casing 12 so as to lock-up the torque-coupling device 10 between the driving shaft 2a and the driven shaft 2b to control sliding movement between the turbine wheel 22 and the impeller wheel 20. Specifically, when sufficient hydraulic pressure in applied to the locking piston 40, the locking piston 40 moves rightward (as shown in FIG. 2) toward the locking surface 18 of the casing 12 and away from the turbine wheel 22, and clamps the friction liner 44 between itself and the locking surface 18 of the casing 12. As a result, the locking piston 40 of the lock-up clutch 15 in the locked position is mechanically frictionally coupled to the casing 12 to bypass the turbine wheel 22 when in the locked position of the lock-up clutch 15. Thus, the lock-up clutch 15 bypasses the turbine wheel 22 when in the locked position thereof.

During operation, when the lock-up clutch 15 is in the disengaged (open) position, the engine torque is transmitted from the impeller wheel 20 by the turbine wheel 22 of the torque converter 14 to the output hub 32 and the driven shaft 2b. When the lock-up clutch 15 is in the engaged (locked) position, the engine torque is transmitted by the casing 12 to the output hub 32 and the driven shaft 2b through the torsional vibration damper 16.

The torsional vibration damper 16 advantageously allows the turbine wheel 22 of the torque converter 14 to be coupled, with torque damping, to the output hub 32, i.e., the input shaft 2b of the automatic transmission. The torsional vibration damper 16 also allows damping of stresses between the driving shaft 2a and the driven shaft 2b that are coaxial with the rotational axis X, with torsion damping.

The torsional vibration damper 16, as best shown in FIGS. 2, 3A and 3B, is disposed axially between the turbine shell 28 of the turbine wheel 22 and the locking piston 40 of the lock-up clutch 15. The locking piston 40 of the lock-up clutch 15 is rotatably and axially slidably mounted to the output hub 32. The torsional vibration damper 16 is positioned on the output hub 32 in a limited, movable and centered manner. The locking piston 40 forms an input part of the torsional vibration damper 16.

The torsional vibration damper 16 comprises a torque input member 50 rotatable about the rotational axis X, and an radially elastic member 52 rotatable relative to the torque input member 50 around the rotational axis X and elastically coupled to the torque input member 50. The radially elastic member 52 is non-rotatably coupled to the output hub 32. Accordingly, the radially elastic member 52 elastically couples the output hub 32 to the torque input member 50, as best shown in FIGS. 2 and 3.

The torque input member 50 includes two axially opposite annular, radially oriented side plates, including a first annular, radially oriented side plate 54₁ adjacent to the turbine shell 28, and a second annular, radially oriented side plate 54₂ adjacent to the locking piston 40. The first side plate 54₁ is substantially parallel to and axially spaced apart from the second side plate 54₂, as best shown in FIG. 3B. Moreover, the first and second side plates 54₁ and 54₂, respectively, are non-moveably attached (i.e., fixed) to one another, such as by mechanical fasteners 57. Also, the first side plate 54₁ is substantially identical to the second side plate 54₂, as best shown in FIGS. 2-5 and 7. In view of the structural similarities of the first and second side plates 54₁ and 54₂, and in the interest of simplicity, the following discussion will sometimes use a reference numeral without a letter to designate an entire group of substantially identical structures. For example, the reference numeral 54 will be sometimes used when generically referring to the first and second side plates 54₁ and 54₂ rather than reciting all/both two reference numerals.

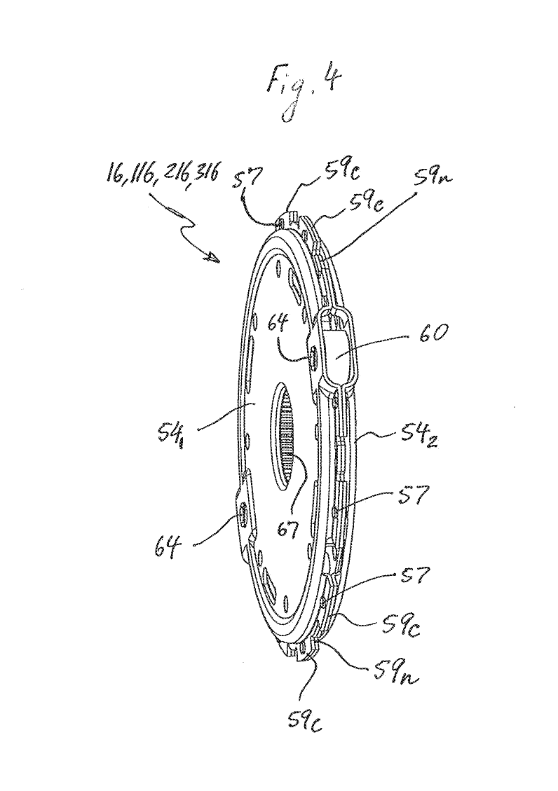

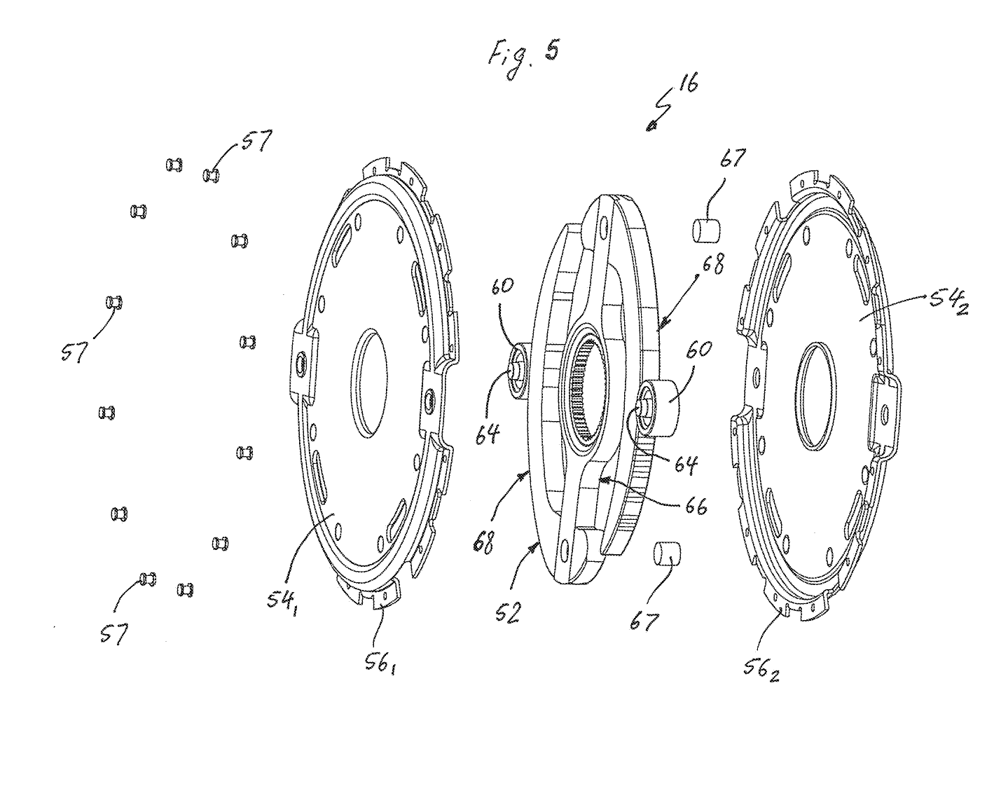

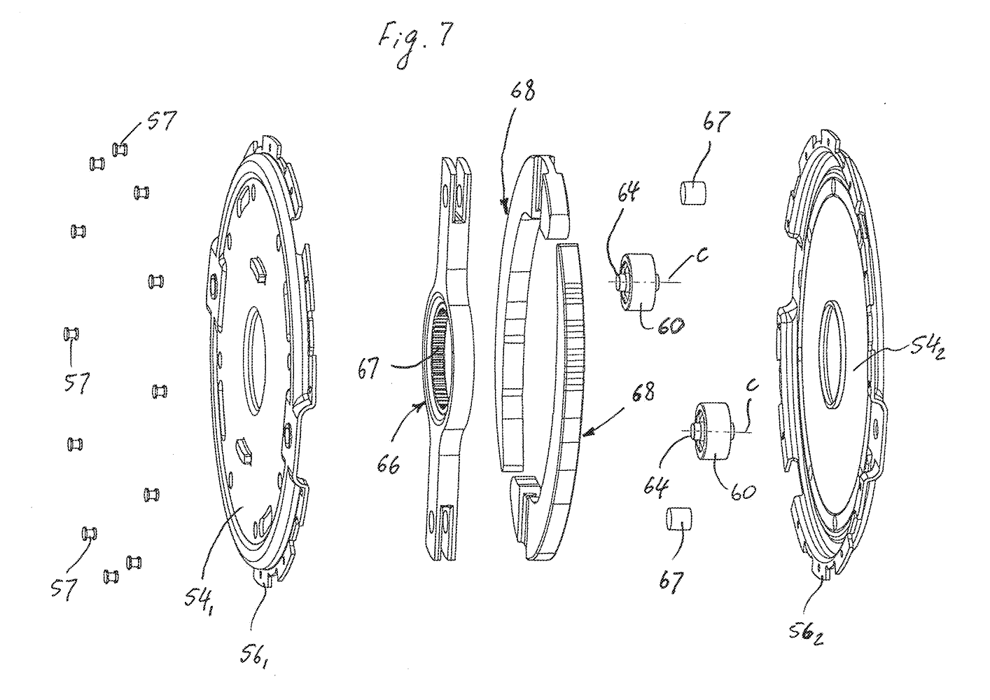

According to the exemplary embodiment of the present invention, as best illustrated in FIGS. 5 and 7, the first side plate 54₁ has a substantially annular outer mounting flange 56₁ provided with a plurality of circumferentially spaced holes. The second side flange 56₂, on the other hand, has a substantially annular outer mounting flange 56₂ provided with a plurality of circumferentially spaced holes. The first and second side plates 54₁ and 54₂ are non-movably (i.e., fixedly) secured to one another so that the outer mounting flanges 56₁, 56₂ of the first and second side plates 54₁, 54₂, respectively, axially engage one another and are fixed together by rivets 57 extending through the holes in the outer mounting flanges 56₁, 56₂ of the first and second damper side plates 54₁, 54₂, as best shown in FIG. 4. Thus, the first and second side plates 54₁, 54₂ are non-rotatable relative to one another, but rotatable relative to the radially elastic member 52.

As further illustrated in FIGS. 2 and 3A, the torque input member 50 (i.e., the first and second side plates 54₁, 54₂) is non-rotatably coupled to the locking piston 40 of the lock-up clutch 15. The first and second side plates 54₁, 54₂ are arranged axially on either side of the radially elastic member 52 and are operatively connected therewith. As described above, the first and second side plates 54₁, 54₂ are non-movably (i.e., fixedly) secured to one another by appropriate means, such as by the mechanical fasteners 57 to be rotatable relative to the radially elastic member 52.

The torque input member 50 further includes at least one, preferably two, supporting members 60, as best shown in FIG. 3B. In the exemplary embodiment, the supporting members 60 are in the form of annular rolling bodies, such as cylindrical rollers, rotatably mounted to a radially external periphery of the first side plate 54₁ and the second side plate 54₂, axially between the first and second side plates 54₁ and 54₂, respectively. Each of the rolling bodies 60 is rotatable around a central axis C, best shown in FIG. 7. The central axis C of each rolling body 60 is substantially parallel to the rotational axis X.

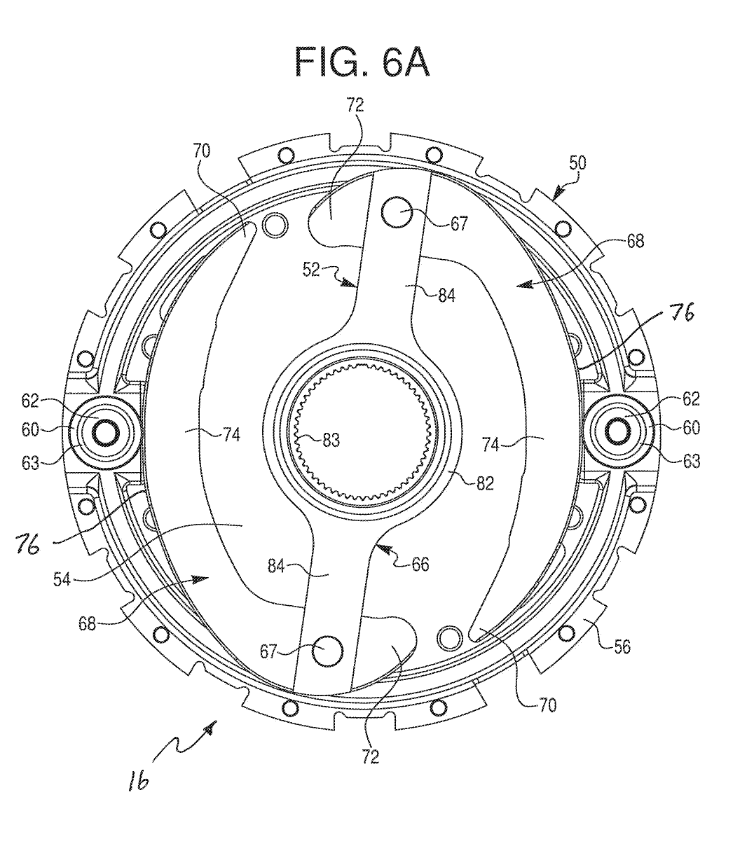

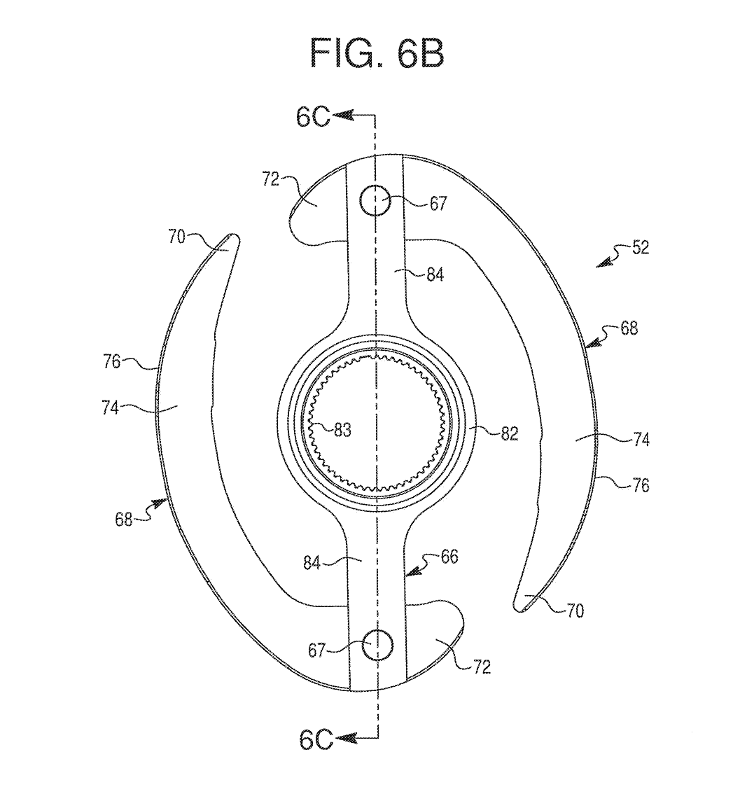

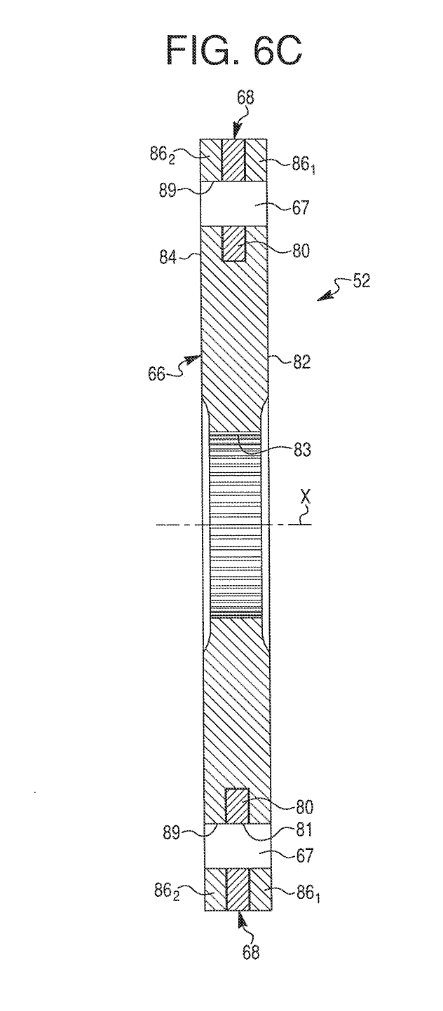

The rolling bodies 60 are positioned so as to be diametrically opposite to one another, as best shown in FIG. 6A. More specifically, the rolling bodies 60 are rotatably mounted about hollow shafts 62, which axially extend between the first and second side plates 54₁ and 54₂. The hollow shafts 62 are mounted on support pins 64 extending axially through the hollow shafts 62, and between and through the first and second side plates 54₁ and 54₂, as best shown in FIG. 4. The rolling bodies 60 are rotatably mounted on the hollow shafts 62 through roller bearings, such as needle bearings 63, for instance, as best shown in FIG. 6A. In other words, the rolling bodies 60 are rotatable around the central axes C and about the support pins 64 mounted to the first and second side plates 54₁ and 54₂ of the torque input member 50.

The lock-up clutch 15 is configured to non-rotatably couple the casing 12 and the torque input member 50 in the engaged (lockup) position, and configured to drivingly disengage the casing 12 and the torque input member 50 in the disengaged (non-lockup) position.

The locking piston 40 further comprises at least one, preferably a plurality, of coupling lugs 48 axially extending from a radially outer peripheral end 41₁ toward the torque input member 50 and the turbine shell 28, as shown in FIG. 3B. The locking piston 40 with the axially extending coupling lugs 48 is preferably an integral part, e.g., made of a single or unitary (i.e., made as a single part) component, but may be made of separate components fixedly connected together. The torque input member 50, on the other hand, includes at least one, preferably a plurality, of notches (or recesses) 59n, each complementary to one of the coupling lugs 48. Specifically, the notches 59n are provided in the outer mounting flanges 56₁, 56₂ of the first and second retainer plates 54₁, 54₂, as best shown in FIG. 4. The notches 59n are separated from each other by radially outwardly extending cogs (or teeth) 59c. Each of the coupling lugs 48 positively engages one of the complementary notches 59n so as to non-rotatably couple the locking piston 40 and the torque input member 50 while allowing an axial motion of the locking piston 40 with respect to the torque input member 50, as best shown in FIGS. 2 and 3B.

The cylindrical rim 46 of the locking piston 40 is mounted to the output hub 32 so as to be centered, rotatable and axially slidably displaceable relative to the output hub 32. The locking piston 40 is also axially slidably displaceable relative to the torque input member 50 of the torsional vibration damper 16. The axial displacement of the locking piston 40 along the output hub 32 is controlled by the pressure chambers 23₁, 23₂ positioned on axially opposite sides of the locking piston 40.

The radially elastic member 52 includes a central part 66 coaxial with the rotational axis X and rotatable relative the torque input member 50, and at least one, preferably two substantially identical, radially opposite curved elastic blades (or leaves) 68 formed separately from one another and the central part 66, as best shown in FIGS. 5-8. The radially elastic member 52 further includes at least one, preferably two substantially identical mounting pins 67 each configured for securing one of the elastic blades 68 to the central part 66, as best shown in FIGS. 5-7.

The radially elastic member 52 is configured to be elastically and radially supported by the rolling bodies 60 and to elastically bend (or deform) in the radial direction upon rotation of the torque input member 50 with respect to the radially elastic member 52. The central part 66 is configured to non-rotatably couple to the output hub 32. At the same time, the central part 66 of the radially elastic member 52 is axially moveable relative to the output hub 32 due to a splined connection therebetween. Accordingly, the radially elastic member 52 is non-rotatably coupled to the output hub 32.

As best shown in FIGS. 5 and 6B, each of the curved elastic blades 68 is symmetrical with respect to the rotational axis X. Moreover, each of the curved elastic blades 68 has a free distal (or first) end 70, a proximal (or second) end 72, and a curved raceway portion 74 disposed between the free distal end 70 and the proximal end 72 of the elastic blades 68 for bearing one of the rolling bodies 60.

Each of the curved elastic blades 68 is radially elastically deformable relative to the central part 66. A radially external surface of the curved raceway portion 74 of each of the elastic blades 68 defines a radially outer raceway 76 configured as a surface that is in rolling contact with one of the rolling bodies 60, so that each of the rolling bodies 60 is positioned radially outside of the elastic blade 68, as illustrated in FIGS. 2, 3B and 6A. The raceways 76 of the curved raceway portions 74 of the curved elastic blades 68 extend on a circumference with an angle ranging from about 120° to about 180°. The raceway 76 of each of the curved raceway portions 74 has a generally convex shape, as best shown in FIGS. 5-8.

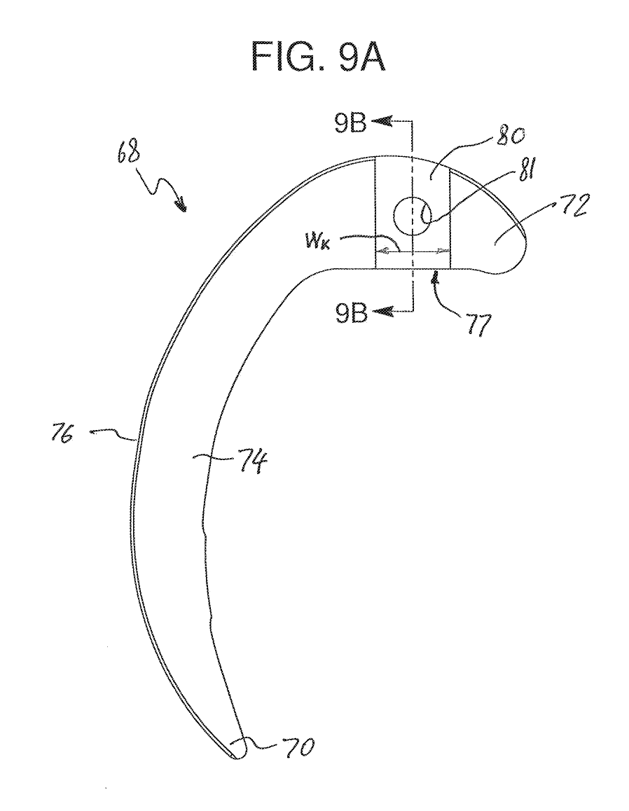

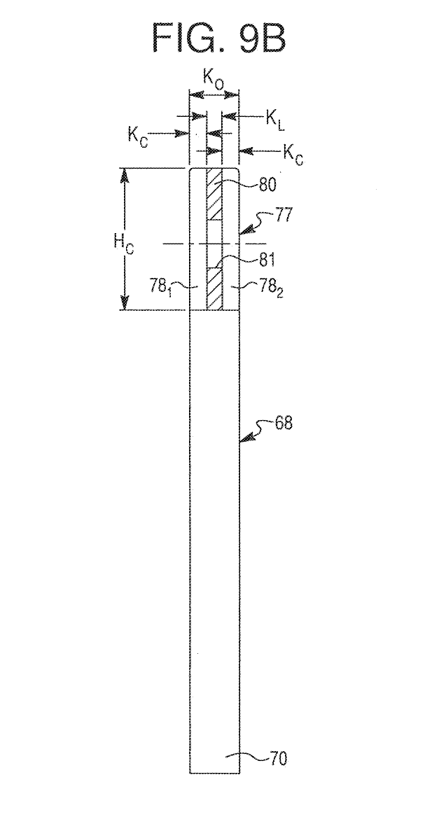

Each of the curved elastic blades 68 also has a connecting portion 77 non-rotatably connected to the central part 66 of the radially elastic member 52. The connecting portion 77 is preferably disposed between the proximal end 72 and the curved raceway portions 74 of the curved elastic blade 68, as best shown in FIG. 9A. The connecting portion 77 of the curved elastic blade 68 includes a connecting link 80 separating axially opposite connecting channels 78₁ and 78₂, as best shown in FIG. 9B. Moreover, the connecting link 80 is of reduced thickness and connects the proximal end 72 with the curved raceway portions 74 of the curved elastic blade 68. As best shown in FIG. 9B, the connecting link 80 has a thickness K_{C} in the axial direction less than the thickness K_{O} of the curved raceway portion 74 of the elastic blade 68. The elastic blade 68 is formed with a mounting hole 81 through the connecting link 80 thereof.

According to the first exemplary embodiment of the present invention, the connecting channels 78₁ and 78₂ are dimensionally (i.e., geometrically) identical to each other, and are axially separated by the connecting link 80, as best shown in FIG. 9B. In other words, each of the connecting channels 78₁ and 78₂ has a height a width W_{K} and a thickness K_{C}, as shown in FIGS. 9A and 9B. Alternatively, the connecting channels 78₁ and 78₂ are may have different height, width and/or thickness. In turn, the connecting portion 77 has the height H_{C} (the same as the height of each of the connecting channels 78₁ and 78₂), the width W_{K} (the same as the width of each of the connecting channels 78₁ and 78₂), and a thickness K_{L}.

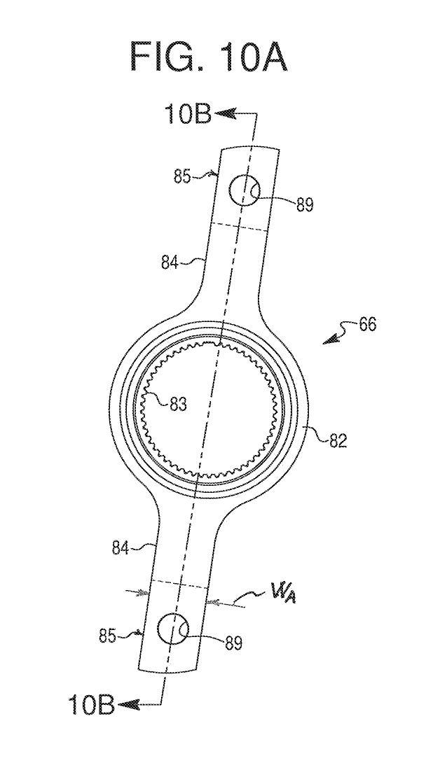

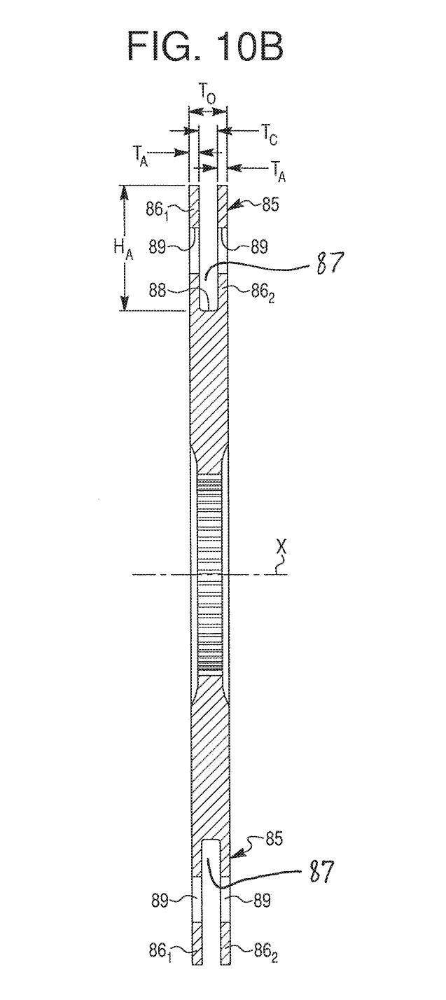

The central part 66 includes an annular central core member 82 coaxial with the rotational axis X, and at least one, preferably two substantially identical mounting arm members 84 extending radially outwardly from the central core member 80, as best shown in FIG. 10A. A radially inner surface of the central core member 82 includes internal splines 83 for directly and non-rotatably engaging the complementary external splines 39 of the output hub 32. The central part 66 is preferably formed integrally with the central core member 82 and the mounting arm members 84, such as a single part made, for example, by press-forming one-piece metal sheets, or a part made of separate components fixedly (i.e., non-moveably) connected together. Each of the mounting arm members 84 is non-moveably connected to the connecting portion 77 of one of the curved elastic blades 68.

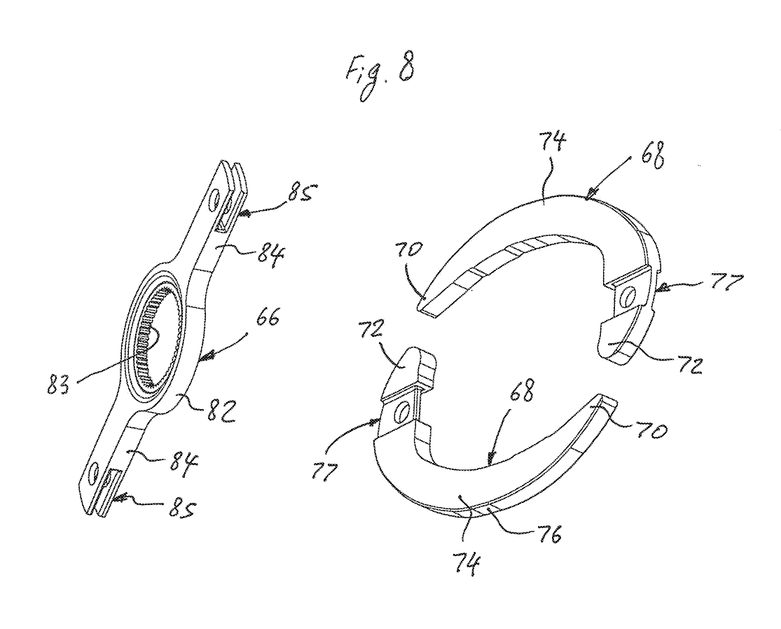

As shown in FIGS. 8, 10A and 10B, a radially distal end of each of the mounting arm members 84 has a mounting portion 85 configured to non-rotatably engage the connecting portion 77 of an associated elastic blade 68 to the central part 66 of the elastic member 52. According the first exemplary embodiment of the present invention, the mounting portion 85 of each of the mounting arm members 84 of the central part 66 is in the form of a U-shaped (or fork-shaped) mounting bracket. The U-shaped mounting bracket 85 includes two flat, axially opposite sidewalls (or fork halves) 86₁ and 86₂, and a bottom wall 88.

The axially opposite sidewalls 86₁ and 86₂ are dimensionally (i.e., geometrically) identical to each other, axially spaced apart from and parallel to each other. The mounting bracket 85 further includes an engaging socket 87 delimited by the opposite sidewalls 86₁, 86₂ and the bottom wall 88. The engaging socket 87 is geometrically complementary to the connecting link 80 of the connecting portion 77 of each of the curved elastic blades 68. In other words, the engaging socket 87 has a height H_{A}, a width W_{A} and a thickness T_{C} substantially equal or slightly larger than the height H_{C}, the width W_{K} and a thickness K_{L} of the connecting link 80 of the curved elastic blades 68. Thus, the engaging socket 87 of the mounting bracket 85 has a shape geometrically complementary to the cross-section of the connecting link 80 of the curved elastic blade 68. The connecting link 80 of the curved elastic blade 68 is also geometrically complementary to each of the sidewalls 86₁ and 86₂ of the mounting arm members 84 of the central part 66. Accordingly, as best shown in FIGS. 5 and 6B, a radially outer peripheral surface of the curved elastic blade 68 is coplanar with radially outer peripheral surfaces of the sidewalls 86₁ and 86₂ of the mounting arm members 84 of the central part 66.

Each of the opposite sidewalls 86₁, 86₂ is geometrically complementary to one of the connecting channels 78₁, 78₂ of the connecting portion 77 of the curved elastic blades 68. In other words, each of the opposite sidewalls 86₁, 86₂ has a thickness T_{A}, width W_{A} and height H_{A} substantially equal or slightly smaller than the height H_{C}, the width W_{K} and thickness K_{C} of one of the connecting channels 78₁, 78₂ of the connecting portion 77 of the curved elastic blades 68. Alternatively, the sidewalls 86₁ and 86₂ may have different height, width and thickness, but are nevertheless geometrically complementary to the connecting channels 78₁ and 78₂.

Each elastic blade 68 is formed with a mounting hole 81 through the connecting link 80 thereof. In turn, each of the sidewalls 86₁ and 86₂ is provided with a through hole 89. The through holes 89 are coaxially aligned with each other. Moreover, each of the through holes 89 in the opposite fork sidewalls 86₁ and 86₂ is coaxially aligned with the mounting hole 81 through the elastic blade 68 and is dimensioned to allow the passage of the mounting pin 67 therethrough, as best shown in FIGS. 5, 6A and 6B. Each of the through holes 89 and the associated mounting hole 81 is just slightly larger in diameter than the mounting pin 67.

The connecting link 78 of each curved elastic blade 68 is non-rotatably mounted in the engaging socket 87 of the mounting bracket 85 between the two opposite sidewalls 86₁ and 86₂. Specifically, the connecting link 78 of the curved elastic blade 68 is slidably fitted into the complementary engaging socket 87 of the mounting arm member 84 of the central part 66 without rotation relative thereto. In other words, the mounting arm member 84 of the central part 66 fixes the elastic blade 68 in the axial and angular directions. On the other hand, the mounting pin 67 extending through the holes 89 in the opposite fork sidewalls 86₁ and 86₂ and the mounting hole 81 in the elastic blade 68 fixes the elastic blade 68 relative to the central part 66 in the radial direction. As a result, the connection portion 77 of the elastic blade 68 is non-rotatably connected to the central part 66 of the elastic member 52 to provide a secure connection and prevent relative motion in the rotational and radial directions between the curved elastic blade 68 and the central part 66 of the radially elastic member 52.

Each central part 66 and curved elastic blade 68 is preferably an integral (or unitary) component. Preferably, each central part 66 and curved elastic blade 68 is made of steel as a single-piece part by fine stamping and appropriate heat treatment. Specifically, the central part 66 of the radially elastic member 52 is made of metal, such as steel, subjected to metal treatment, such as quenching, tempering, and/or shot peening, to have core hardness of 38-52 HRC. The curved elastic blades 68 are made of metal, such as steel, subjected to metal treatment, such as induction hardening and stress relieving, to have a core hardness of 44-60 HRC. Thus, each central part 66 and associated curved elastic blade 68 are made of materials having different mechanical properties. Specifically, each central part 66 is made of a material having first characteristics, and the associated curved elastic blades 68 are made of another material having second characteristics, which are different from the first characteristics. In other words, the materials of the central part 66 and the associated curved elastic blades 68 have different mechanical properties. Specifically, the second material of the curved elastic blades 68 has higher hardness than the first material of the central part 66. It will be understood that the materials forming the central part 66 and the elastic blades 68 may also have different compositions.

The lock-up clutch 15 is configured to non-rotatably couple the casing 12 and the torque input member 50 in the engaged (lockup) position, and configured to drivingly disengage the casing 12 and the torque input member 50 in the disengaged (non-lockup) position.

In operation, when a rolling body 60 moves along the raceway 76 of the curved raceway portion 74 of the elastic blade 68, the rolling body 60 presses the curved raceway portion 76 of the elastic blade 68 radially inwardly, thus maintaining contact of the rolling body 60 with the curved raceway portion 74 of the elastic blade 68, as best illustrated in FIGS. 5 and 6A. Radial forces make it possible for the elastic blade 68 to bend (or deform) and forces tangential to the raceway 76 of the elastic leaf 68 make it possible for the rolling body 60 to move (roll) on the raceway 76 of the elastic blade 68 and to transmit torque from the torque input member 50 to the central part 66 of the radially elastic member 52, and then to the output hub 32. Thus, the central part 66 of the radially elastic member 52, which is splined directly with the output hub 32, forms an output part of the torsional vibration damper 16 and a driven side of the torque-coupling device 10. The locking piston 40, on the other hand, forms an input part of the torsional vibration damper 16. The torque from the driving shaft (or crankshaft) 2a is transmitted to the casing 12 through the flexplate 11 and the studs 13, as best shown in FIG. 2.

In the disengaged position of the lock-up clutch 15, the torque goes through the torque converter 14, i.e. the impeller wheel 20 and then the turbine wheel 22 fixed to the output hub 32. The torque is then transmitted to the driven shaft (transmission input shaft) splined directly to the output hub 32.

In the engaged position of the lock-up clutch 15, the torque from the casing 12 is transmitted to the torque input member 50 (i.e., the first and second side plates 54₁ and 54₂, and the rolling bodies 60) through the locking piston 40. Then, the torque from the torque input member 50 is transmitted to the output hub 32 through the radially elastic member 52 formed by the central part 66 and the elastic blades 68. Specifically, the torque is transmitted from the central part 66 of the radially elastic member 52 to the output hub 32. Next, the torque is transmitted from the output hub 32 to the driven shaft (transmission input shaft) 2b splined directly to the output hub 32. Moreover, when the torque transmitted between the casing 12 and the output hub 32 varies, the radial stresses exerted between each of the elastic leaves 68 and the corresponding rolling body 60 vary and the bending of the elastic blades 68 is modified. The modification in the bending of the elastic blades 68 arise due to motion of the rolling body 60 along the corresponding raceway 76 of the curved elastic blade 68 due to peripheral stresses.

The raceway 76 has a profile arranged so that, as the transmitted torque increases, the rolling body 60 exerts a bending force on the corresponding curved elastic blade 68, which causes the free distal end 70 of the curved elastic blade 68 to move radially towards the rotational axis X and produces a relative rotation between the casing 12 and the central core member 82 of the central part 66 of the elastic output member 52, such that both the casing 12 and the output hub 32 move away from their relative rest positions. A rest position is the position of the torque input member 50 relative to the radially elastic member 52 wherein no torque is transmitted between the casing 12 and the output hub 32 through the rolling bodies 60.

The profiles of the raceways 76 are such that the rolling bodies 60 exert bending forces (pressure) having radial and circumferential components onto the curved elastic blades 68. Specifically, the elastic blades 68 are configured so that in a relative angular position between the torque input member 50 and the elastic member 52 different from the rest position, each of the rolling bodies 60 exerts a bending force on the corresponding elastic blade 68, thus causing a reaction force of the elastic blade 68 acting on the rolling body 60, with the reaction force having a radial component which tends to maintain the elastic blade 68 in contact with the rolling body 60.

In turn, each of the elastic blades 68 exerts onto the corresponding rolling body 60 a back-moving force having a circumferential component which tends to rotate the rolling bodies 60 in a reverse direction of rotation, and thus to move the torque input member 50 and the output hub 32 back towards their relative rest positions, and a radial component directed radially outwardly, which tends to maintain each of the raceways 76 in direct contact with the corresponding rolling body 60.

When the casing 12 and the elastic member 52 are in the rest position, the elastic blades 68 are preferably radially pre-stressed toward the rotational axis X so as to exert a reaction force directed radially outwards, to thus maintain the curved elastic blades 68 supported by the associated rolling bodies 60.

Moreover, the profiles of the raceways 76 are so arranged that a characteristic transmission torque curve according to the angular displacement of the rolling body 60 relative to the raceway 76 is configured to be symmetrical or asymmetrical relative to the rest position. According to the exemplary embodiment, the angular displacement of the rolling body 60 relative to the raceway 76 is greater in a direct direction of rotation than in a reverse (i.e., opposite to the direct) direction of rotation.

According to the exemplary embodiment, the angular displacement of the casing 12 relative to the radially elastic member 52 in the locked position of the lock-up clutch 15 is greater than 20°, preferably greater than 40°. The curved elastic blades 68 are regularly distributed around the rotational axis X and are symmetrical relative to the rotational axis X to ensure the balance of the torque converter 14.

A method for assembling the hydrokinetic torque-coupling device 10 is as follows. It should be understood that this exemplary method may be practiced in connection with the other embodiments described herein. This exemplary method is not the exclusive method for assembling the turbine assembly described herein. While the methods for assembling the hydrokinetic torque-coupling device 10 may be practiced by sequentially performing the steps as set forth below, it should be understood that the methods may involve performing the steps in different sequences.

First, the impeller wheel 20, the turbine wheel 22, the stator 24, and the damper assembly 16 may each be preassembled. The impeller wheel 20 and the turbine wheel 22 are formed by stamping from steel blanks or by injection molding of a polymeric material. The stator 24 is made by casting from aluminum or injection molding of a polymeric material. The impeller wheel 20, the turbine wheel 22 and the stator 24 subassemblies are assembled together to form the torque converter 14. Next, the turbine shell 28 of the turbine wheel 22 is non-movably (i.e., fixedly) secured to the flange 36 of the output hub 32 by the rivets 37 (best shown in FIG. 3) or by any other appropriate means, such as welding.

The torsional vibration damper 16 is then added. First, the central part 66, and the at least one, preferably two substantially identical, radially opposite curved elastic blades 68 of the radially elastic member 52 are formed separately from one another. Each of the central part 66 and the elastic blades 68 is made as an integral (or unitary) component, e.g., made as a single part, but may be made of separate components fixedly connected together. Each of the elastic blades 68 is formed with the connecting portion 77 including the axially opposite connecting channels 78₁ and 78₂ separated by the connecting link 80. Each of the mounting arm members 84 of the central part 66 is formed with the mounting portion 85 in the form of the U-shaped (or fork-shaped) mounting bracket having two flat, axially opposite sidewalls 86₁ and 86₂, and a bottom wall 88. The mounting portion 85 defines the engaging socket 87 delimited by the opposite sidewalls 86₁, 86₂ and the bottom wall 88 and geometrically complementary to the connecting link 80 of the connecting portion 77 of the elastic blade 68. The central part 66 of the radially elastic member 52 is preferably made of metal, such as steel, subjected to metal treatment, such as quench, tempering, shot peening, to have core hardness 38-52 HRC. The curved elastic blades 68 are preferably made of metal, such as steel, subjected to metal treatment, such as induction hardening and stress relieving, to have core hardness 44-60 HRC. Thus, the central part 66 and the curved elastic blades 68 are made of materials having different chemical composition and/or mechanical properties. Thus, the second material of the curved elastic blade 68 has higher hardness than the first material of the central part 66.

Next, the connecting portion 77 of each of the elastic blades 68 is non-rotatably mounted to the mounting bracket 85 of one of the opposite mounting arm members 84. Specifically, the connecting link 80 of the connecting portion 77 of each of the curved elastic blades 68 is radially slidably inserted into the complementary engaging socket 87 of the mounting bracket 85 of the central part 66. Then, the mounting pin 67 is inserted into one of the through the holes 89 in one of the opposite fork sidewalls 86₁ and 86₂ to extend through both of the through holes 89 in the opposite fork sidewalls 86₁ and 86₂ and the mounting hole 81 in the elastic blade 68. As a result, the connection portion 77 of each of the elastic blades 68 is non-moveably connected to one of the opposite mounting arm members 84 of the central part 66 so as to define the elastic member 52, as best shown in FIGS. 5, 6A, 6B and 6C.

Then, the torsional vibration damper 16 is assembled by mounting the assembled radially elastic member 52 between the first and second side plates 54₁ and 54₂ of the torque input member 50. Then, the first and second side plates 54₁ and 54₂ are non-movably (i.e., fixedly) secured (connected) to one another so that the outer mounting flanges 56₁, 56₂ of the first and second side plates 54₁, 54₂ axially engage one another and are fixed by the rivets 57 extending through holes in the outer mounting flanges 56₁, 56₂ of the first and second side plates 54₁, 54₂, as best shown in FIG. 4.

Next, the torsional vibration damper 16 is slidably mounted to the output hub 32 by axially sliding the splines 83 of the core member 66 of the radially elastic member 52 over the complementary splines 39 of the output hub 32 for directly and non-rotatably engaging the output hub 32 with the radially elastic member 52 of the torsional vibration damper 16, as best shown in FIG. 3A.

Then, the locking piston 40 of the lock-up clutch 15 is provided as an integral part with the axially extending coupling lugs 48, made of a single or unitary (i.e., made as a single part) component, but may be made of separate components fixedly connected together. Next, the locking piston 40 is axially displaced toward the torque input member 50 of the torsional vibration damper 16 such that each of the coupling lugs 48 positively engages one of the notches 59n of the torque input member 50 so as to non-rotatably couple the locking piston 40 and the torque input member 50 while allowing an axial motion of the locking piston 40 with respect to the torque input member 50, as best shown in FIGS. 3A and 3B. At the same time, the locking piston 40 is mounted to the output hub 32 so that the cylindrical rim 46 of the locking piston 40 is disposed in the annular groove 38 of the output hub 32, as shown in FIGS. 3A and 3B.

Next, the first shell 17₁ and the second shell 17₂ are non-movably (i.e., fixedly) connected and sealed together about their outer peripheries, such as by a weld 19, as shown in FIG. 2. After that, the hydrokinetic torque-coupling device 10 is mounted to the transmission input shaft so that the output hub 32 is splined directly to the transmission input shaft 2b.

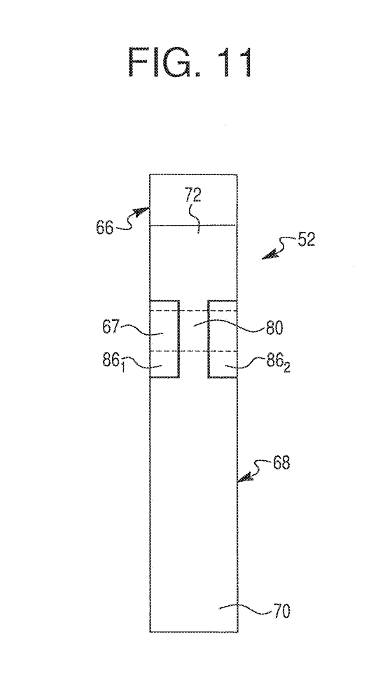

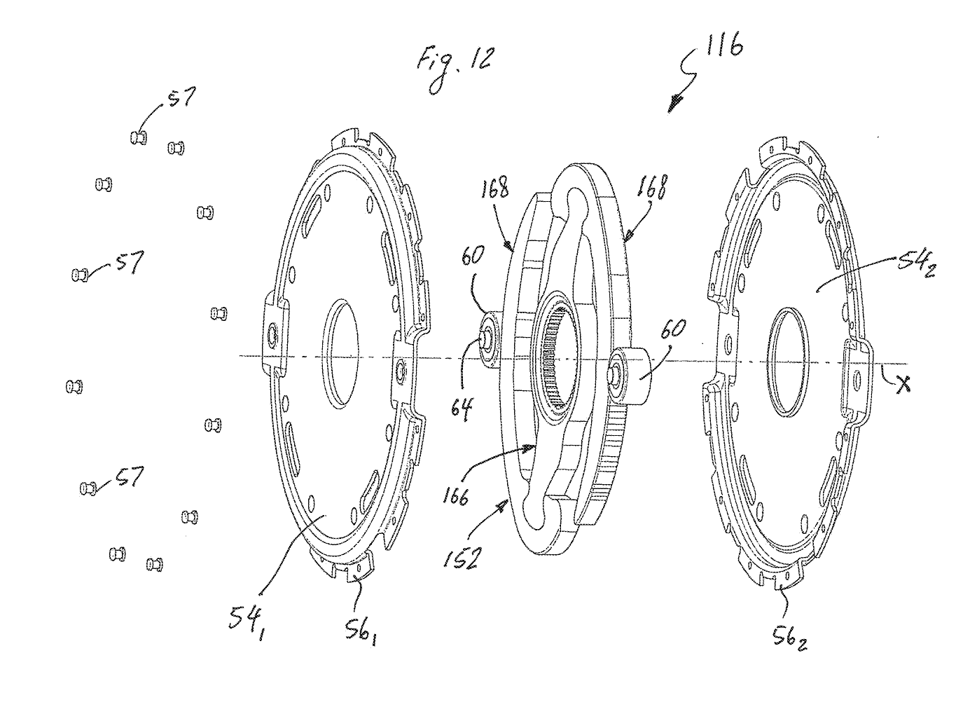

Various modifications, changes, and alterations may be practiced with the above-described embodiment, including but not limited to the additional embodiments shown in FIGS. 12-26. In the interest of brevity, reference characters in FIGS. 12-26 that are discussed above in connection with Figs. FIGS. 2-11 are not further elaborated upon below, except to the extent necessary or useful to explain the additional embodiments of FIGS. 12-26. Modified components and parts are indicated by the addition of a hundred digits to the reference numerals of the components or parts.

In a hydrokinetic torque-coupling device 110 of a second exemplary embodiment illustrated in FIGS. 2-4 and 12-15, the torsional vibration damper 16 is replaced by a torsional vibration damper 116. The hydrokinetic torque-coupling device 110 of FIGS. 2-4 and 12-15 corresponds substantially to the hydrokinetic torque-coupling device 10 of FIGS. 2-11, and the torsional vibration damper 116, which primarily differs, will therefore be explained in detail below.

The torsional vibration damper 116 comprises a torque input member 50 rotatable about the rotational axis X, and an radially elastic member 152 rotatable relative to the torque input member 50 around the rotational axis X and elastically coupled to the torque input member 50. The radially elastic member 152 is non-rotatably coupled to the output hub 32. Accordingly, the radially elastic member 152 elastically couples the output hub 32 to the torque input member 50, as best shown in FIGS. 2 and 3.

The torque input member 50 includes two axially opposite annular, radially oriented side plates, including a first annular, radially oriented side plate 54₁ adjacent to the turbine shell 28, and a second annular, radially oriented side plate 54₂ adjacent to the locking piston 40. The first side plate 54₁ is substantially parallel to and axially spaced apart from the second side plate 54₂, as best shown in FIG. 3. Moreover, the first and second side plates 54₁ and 54₂, respectively, are non-moveably attached (i.e., fixed) to one another, such as by mechanical fasteners 57. Also, the first side plate 54₁ is substantially identical to the second side plate 54₂, as best shown in FIGS. 2-5 and 7.

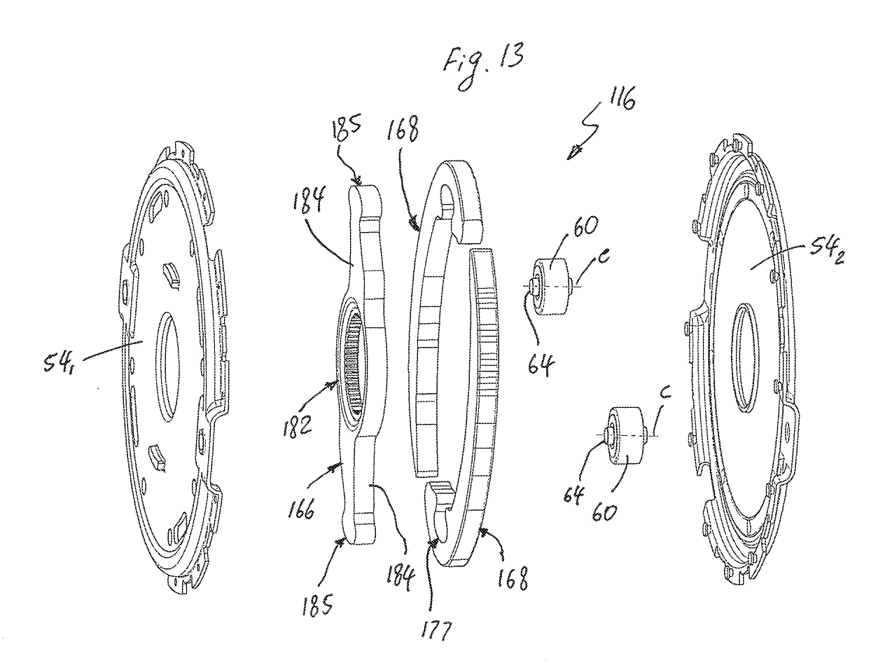

The torque input member 50 further includes at least one, preferably two, supporting members 60. In the exemplary embodiment, the supporting members 60 are in the form of annular rolling bodies, such as cylindrical rollers, rotatably mounted to a radially external periphery of the first side plate 54₁ and the second side plate 54₂, axially between the first and second side plates 54₁ and 54₂, respectively. Each of the rolling bodies 60 is rotatable around a central axis C, best shown in FIG. 13. The central axis C of each rolling body 60 is substantially parallel to the rotational axis X.

The locking piston 40 further comprises at least one, preferably a plurality of coupling lugs 48 axially extending from a radially outer peripheral end 41₁ toward the torque input member 50 and the turbine shell 28, as shown in FIG. 3. The locking piston 40 with the axially extending coupling lugs 48 is preferably an integral part, e.g., made of a single or unitary (i.e., made as a single part) component, but may be made of separate components fixedly connected together. The torque input member 50, on the other hand, includes at least one, preferably a plurality, of notches (or recesses) 59n, each complementary to one of the coupling lugs 48. Each of the coupling lugs 48 positively engages one of the complementary notches 59n to non-rotatably couple the locking piston 40 and the torque input member 50 while allowing an axial motion of the locking piston 40 with respect to the torque input member 50, as best shown in FIGS. 2 and 3.

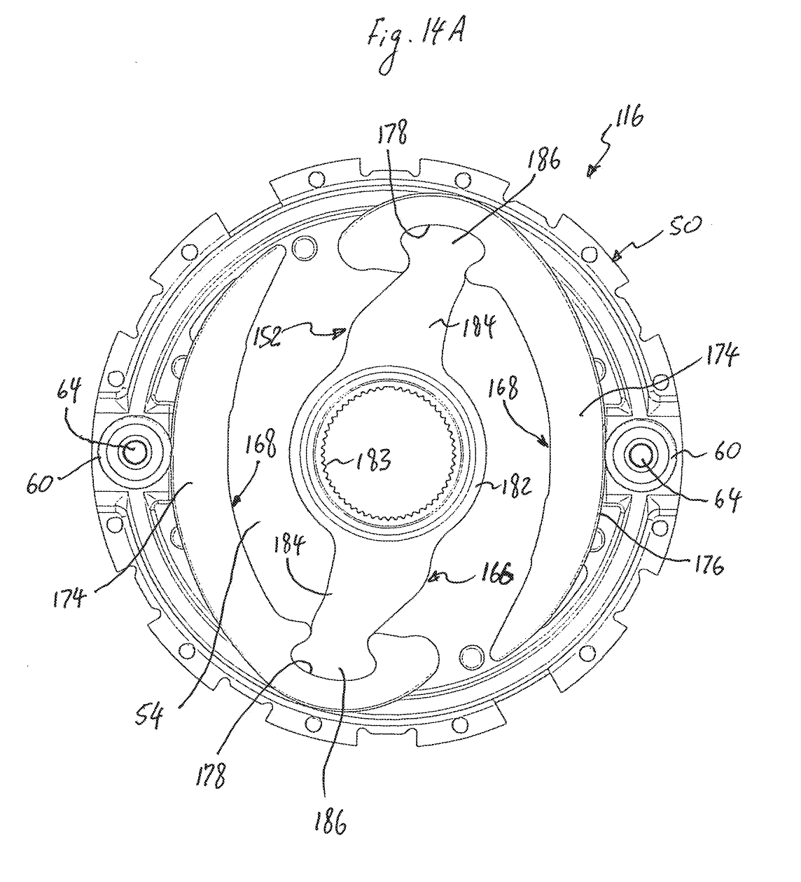

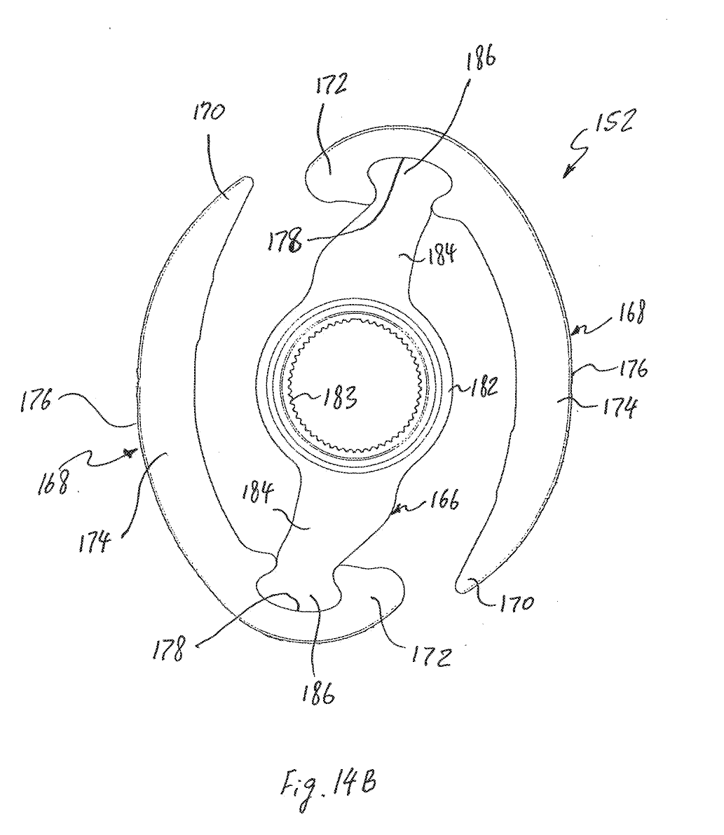

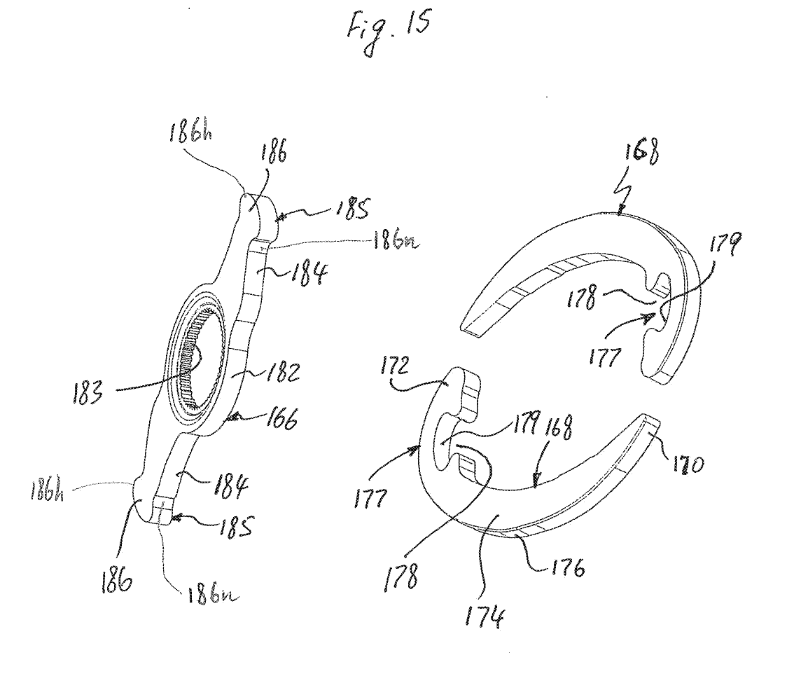

The radially elastic member 152 includes a central part 166 coaxial with the rotational axis X and rotatable relative the torque input member 50, and at least one, preferably two substantially identical, radially opposite curved elastic blades (or leaves) 168 formed separately from one another and the central part 166, as best shown in FIGS. 13 and 15. The radially elastic member 152, as best shown in FIG. 14B, is configured to be elastically and radially supported by the rolling bodies 60 and to elastically bend (or deform) in the radial direction upon rotation of the torque input member 50 with respect to the radially elastic member 152. The central part 166 is configured to non-rotatably couple to the output hub 32. At the same time, the central part 166 of the radially elastic member 152 is axially moveable relative to the output hub 32 due to a splined connection therebetween. Accordingly, the radially elastic member 152 is non-rotatably coupled to the output hub 32.

As best shown in FIGS. 2, 3A, 12 and 14B, each of the curved elastic blades 168 is symmetrical with respect to the rotational axis X. Moreover, each of the curved elastic blades 168 has a free distal (or first) end 170, a proximal (or second) end 172, and a curved raceway portion 174 disposed between the free distal end 170 and the proximal end 172 of the elastic blades 168 for bearing one of the rolling bodies 60.

Each of the curved elastic blades 168 is radially elastically deformable relative to the central part 166. A radially external surface of the curved raceway portion 174 of each of the elastic blades 168 defines a radially outer raceway 176 configured as a surface that is in rolling contact with one of the rolling bodies 60, so that each of the rolling bodies 60 is positioned radially outside of the elastic blade 168, as illustrated in FIGS. 12 and 14A. The raceways 176 of the curved raceway portions 174 of each curved elastic blade 168 extend on a circumference with an angle ranging from about 120° to about 180°. The raceway 176 of each of the curved raceway portions 174 has a generally convex shape, as best shown in FIGS. 12-15.

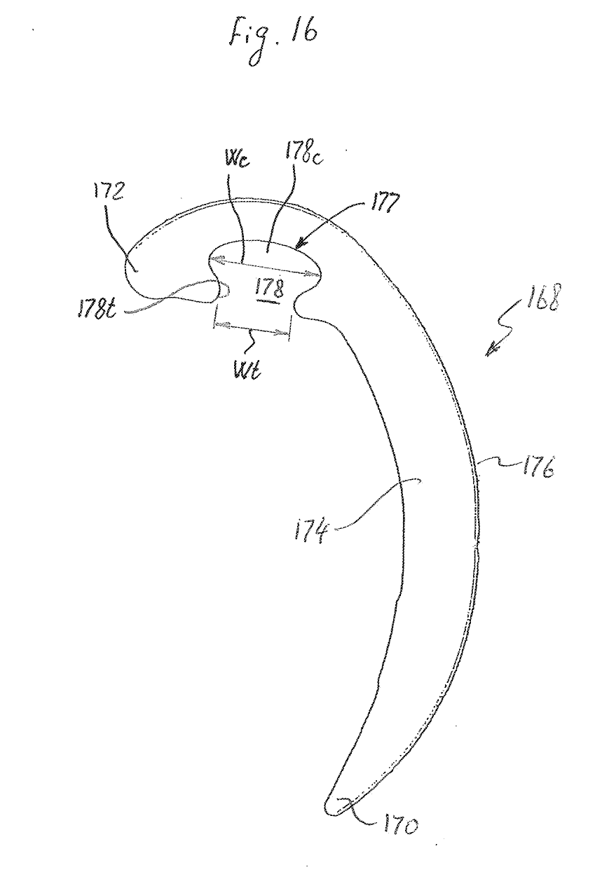

Each of the curved elastic blades 168 also has a connecting portion 177 non-rotatably connected to the central part 166 of the radially elastic member 152. The connecting portion 177 is preferably disposed between the proximal end 172 and the curved raceway portions 174 of the curved elastic blade 168, as best shown in FIGS. 14B and 15. The connecting portion 177 of each curved elastic blade 168 is defined by a radially and axially extending engaging socket 178 having a radially inner peripheral surface 179, as best shown in FIGS. 15 and 16. Preferably, the engaging socket 178 has a non-circular cross-section in the axial direction, i.e., in the direction of the rotational axis X. The engaging socket 178 is in the form of a radially and axially extending connecting channel having an open throat 178t and an engaging cavity 178c, as best shown in FIG. 16. As best shown in FIG. 15, each of the curved elastic blades 168 has a uniform thickness in the axial direction.

The central part 166 includes an annular central core member 182 coaxial with the rotational axis X, and at least one, preferably two substantially identical mounting arm members 184 extending radially outwardly from the central core member 182. A radially inner surface of the central core member 182 includes internal splines 183, as best shown in FIG. 15, for directly and non-rotatably engaging the complementary external splines 39 of the output hub 32. The central part 166 is preferably formed integrally with the central core member 182 and the mounting arm members 184, such as a single part made, for example, by press-forming one-piece metal sheets, or a part made of separate components fixedly (i.e., non-moveably) connected together. Each of the mounting arm members 184 is non-moveably connected to the connecting portion 177 of one of the curved elastic blades 168.

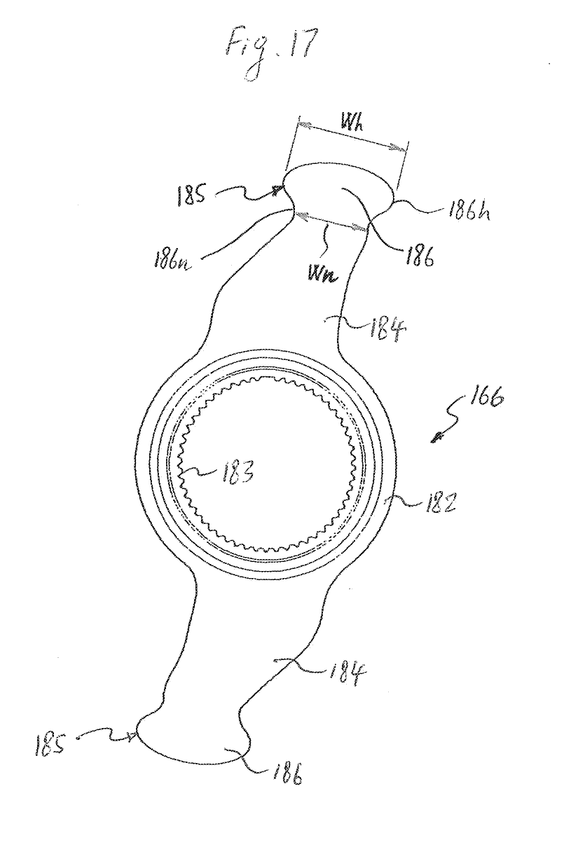

As best shown in FIGS. 13 and 15, a radially distal end of each of the mounting arm members 184 has a mounting portion 185 configured to non-rotatably engage the connecting portion 177 of the elastic blade 168 to the central part 166 of the elastic member 152. According to the second exemplary embodiment of the present invention, the mounting portion 185 of each of the mounting arm members 184 of the central part 166 is in the form of a connecting link 186. The connecting link 186 extends radially outwardly from the mounting arm members 184 of the central part 166. The connecting link 186 of the mounting portion 185 has a shape geometrically complementary to the shape of the engaging socket 178 of the associated curved elastic blade 168. The connecting link 186 has a neck portion 186n and a head portion 186h, as best shown in FIG. 17.

As best shown in FIG. 16, a width We of the engaging cavity 178c is larger than a width Wt of the open throat 178t of the engaging socket 178. On the other hand, as best shown in FIG. 17, a width Wh of the head portion 186h is larger than a width Wn of the neck portion 186n of the connecting link 186. Consequently, the connecting link 186 of the central part 166 is coupled to the complementary engaging socket 178 of the curved elastic blade 168 by axially sliding the connecting link 186 into the engaging socket 178, or vice versa. In addition, the head portion 186h of the connecting link 186 has a shape geometrically complementary to the shape of the engaging cavity 178c of the engaging socket 178. Similarly, the neck portion 186n of the connecting link 186 has a shape geometrically complementary to the shape of the open throat 178t of the engaging socket 178. Thus, the engaging socket 178 of the connecting portion 177 of the curved elastic blade 168 is configured to receive the complementary connecting link 186 of the mounting portion 185 to prevent radial, axial and angular movement of the connecting portion 177 of the curved elastic blade 168 relative to the mounting arm members 184 of the central part 166. In other words, the connecting link 186 is slidably received in and mates with the complementary engaging socket 178 of the curved elastic blade 168 to provide a secure connection and prevent relative motion in the rotational and radial directions between each curved elastic blade 168 and the central part 166 of the radially elastic member 152. Consequently, torque is transferred from the curved elastic blade 168 to the output hub 32 through the central part 166 of the radially elastic member 152. Moreover, the curved elastic blades 168 and the mounting arm members 184 of the central part 166 are axially displaceable relative to each other.

A method for assembling the hydrokinetic torque-coupling device 110 is as follows. First, the impeller wheel 20, the turbine wheel 22, the stator 24, and the damper assembly 16 may each be preassembled. The impeller wheel 20, the turbine wheel 22 and the stator 24 subassemblies are assembled together to form the torque converter 14. Next, the turbine shell 28 of the turbine wheel 22 is non-movably (i.e., fixedly) secured to the flange 36 of the output hub 32 by the rivets 37 (best shown in FIG. 3) or by any other appropriate means, such as welding.

The torsional vibration damper 116 is then added. First, the central part 166, and the at least one, preferably two substantially identical, radially opposite curved elastic blades 168 of the radially elastic member 152 are formed separately from one another. Each of the elastic blades 168 is formed with the connecting portion 177 includes the axially extending engaging socket 178. The mounting portion 185 of each of the mounting arm members 184 of the central part 166 is in the form of a connecting link 186. The connecting link 186 of the mounting portion 185 has a shape geometrically complementary to a shape of the engaging socket 178 of the curved elastic blade 168. Each of the mounting arm members 184 of the central part 166 is formed with the mounting portion 185 has the connecting link 186 having a shape geometrically complementary to a shape of the engaging socket 178 of the curved elastic blade 168. Each of the central part 166 and the elastic blades 168 is made as an integral (or unitary) component, e.g., made as a single part, but may be made of separate components fixedly connected together. The central part 166 of the radially elastic member 152 is preferably made of metal, such as steel, subjected to metal treatment, such as quench, tempering, shot peening, to have core hardness 38-52 HRC. The curved elastic blades 168 are preferably made of metal, such as steel, subjected to metal treatment, such as induction hardening and stress relieving, to have core hardness 44-60 HRC. Thus, the central part 166 and the curved elastic blades 168 are made of materials having different chemical composition and/or mechanical properties. Thus, the second material of the curved elastic blade 168 has higher hardness than the first material of the central part 166.

Next, the connecting portion 177 of each of the elastic blades 168 is non-rotatably secured to the mounting portion 185 of one of the opposite mounting arm members 184. Specifically, the connecting link 186 of the mounting portion 185 of each of the mounting arm members 184 of the central part 166 is axially slidably inserted into the complementary engaging socket 178 of the connecting portion 177 of one of the curved elastic blade 168. As a result, the connection portion 177 of each of the elastic blades 168 is non-rotatably connected to one of the opposite mounting arm members 184 of the central part 166 so as to define the elastic member 152, as best shown in FIGS. 12, 14A and 14B.

Then, the torsional vibration damper 116 is assembled by placing the assembled radially elastic member 152 between the first and second side plates 54₁ and 54₂ of the torque input member 50. Then, the first and second side plates 54₁ and 54₂ are non-movably (i.e., fixedly) secured (connected) to one another so that the outer mounting flanges 56₁, 56₂ of the first and second side plates 54₁, 54₂ axially engage one another and are fixed by the rivets 57 extending through holes in the outer mounting flanges 56₁, 56₂ of the first and second side plates 54₁, 54₂, as best shown in FIG. 4.

Next, the torsional vibration damper 116 is slidably mounted to the output hub 32 by axially sliding the splines 183 of the core member 166 of the radially elastic member 152 over the complementary splines 39 of the output hub 32 for directly and non-rotatably engaging the output hub 32 with the radially elastic member 152 of the torsional vibration damper 16, as best shown in FIG. 3A.

Then, the locking piston 40 is axially displaced toward the torque input member 50 of the torsional vibration damper 116 such that each of the coupling lugs 48 positively engages one of the notches 59n of the torque input member 50 so as to non-rotatably couple the locking piston 40 and the torque input member 50 while allowing an axial motion of the locking piston 40 with respect to the torque input member 50, as best shown in FIGS. 3A and 3B. At the same time, the locking piston 40 is mounted to the output hub 32 so that the cylindrical rim 46 of the locking piston 40 is disposed in the annular groove 38 of the output hub 32, as shown in FIGS. 3A and 3B.

Next, the first shell 17₁ and the second shell 17₂ are non-movably (i.e., fixedly) connected and sealed together about their outer peripheries, such as by a weld 19, as shown in FIG. 2. After that, the hydrokinetic torque-coupling device 110 is mounted to the transmission input shaft so that the output hub 32 is splined directly to the transmission input shaft 2b.

In a hydrokinetic torque-coupling device 210 of a third exemplary embodiment illustrated in FIGS. 2-4 and 18-23, the torsional vibration damper 116 is replaced by a torsional vibration damper 216. The hydrokinetic torque-coupling device 210 of FIGS. 2-4 and 18-23 corresponds substantially to the hydrokinetic torque-coupling device 110 of FIGS. 2-4 and 12-17, and the torsional vibration damper 216, which primarily differs, will therefore be explained in detail below.

The torsional vibration damper 216 comprises a torque input member 50 rotatable about the rotational axis X, and a radially elastic member 252 rotatable relative to the torque input member 50 around the rotational axis X and elastically coupled to the torque input member 50. The radially elastic member 252 is non-rotatably coupled to the output hub 32. Accordingly, the radially elastic member 252 elastically couples the output hub 32 to the torque input member 50, as best shown in FIGS. 2 and 3.

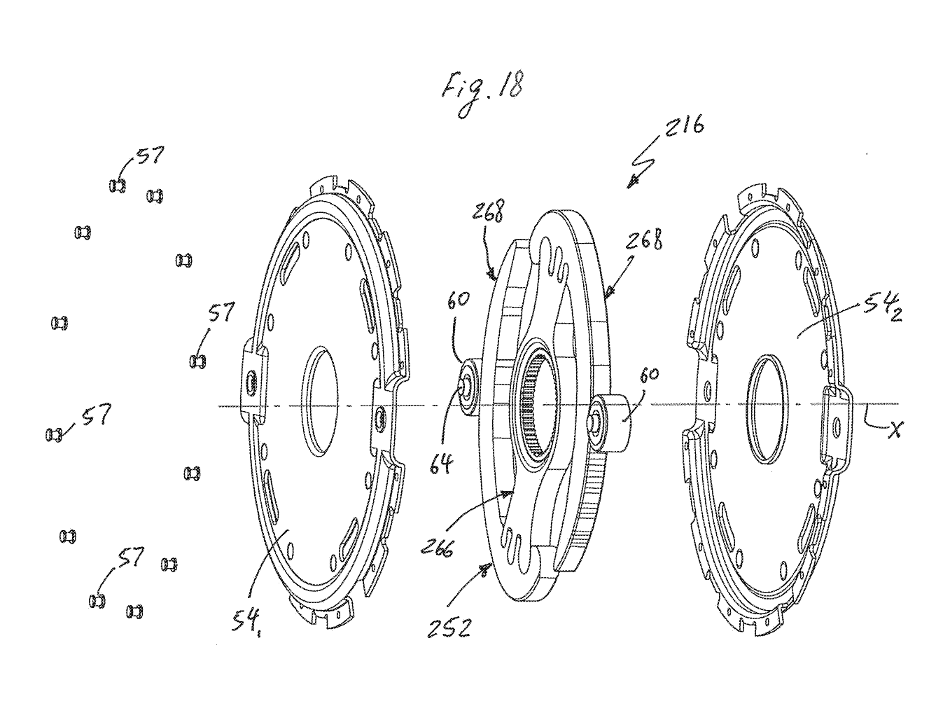

The radially elastic member 252 includes a central part 266 coaxial with the rotational axis X and rotatable relative the torque input member 50, and at least one, preferably two substantially identical, radially opposite curved elastic blades (or leaves) 268 formed separately from one another and the central part 266, as best shown in FIGS. 18, 19 and 21. The radially elastic member 252 is configured to be elastically and radially supported by the rolling bodies 60 and to elastically bend (or deform) in the radial direction upon rotation of the torque input member 50 with respect to the radially elastic member 252. The central part 266 is configured to non-rotatably couple to the output hub 32. At the same time, the central part 266 of the radially elastic member 252 is axially moveable relative to the output hub 32 due to a splined connection therebetween. Accordingly, the radially elastic member 252 is non-rotatably coupled to the output hub 32.

As best shown in FIGS. 2, 3A, 18 and 20B, each of the curved elastic blades 268 is symmetrical with respect to the rotational axis X. Moreover, each of the curved elastic blades 268 has a free distal (or first) end 270, a proximal (or second) end 272, and a curved raceway portion 274 disposed between the free distal end 270 and the proximal end 272 of the elastic blade 268 for bearing one of the rolling bodies 60.

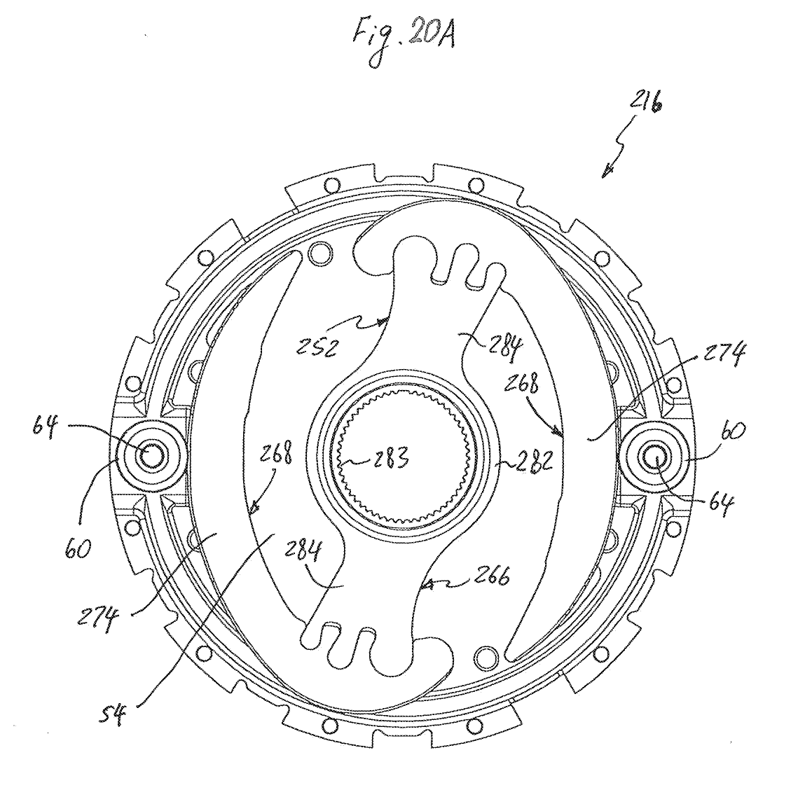

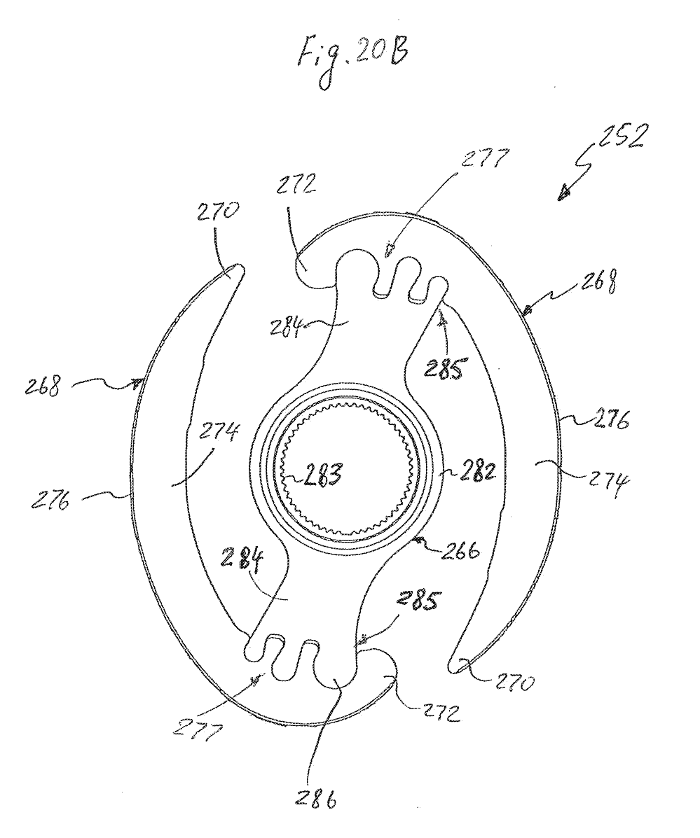

Each of the curved elastic blades 268 is radially elastically deformable relative to the central part 266. A radially external surface of the curved raceway portion 274 of each of the elastic blades 268 defines a radially outer raceway 276 configured as a surface that is in rolling contact with one of the rolling bodies 60, so that each of the rolling bodies 60 is positioned radially outside of the elastic blade 268, as illustrated in FIGS. 18 and 20A. The raceway 276 of the curved raceway portion 274 of each curved elastic blade 268 extends on a circumference with an angle ranging from about 120° to about 180°. The raceway 276 of each of the curved raceway portions 274 has a generally convex shape, as best shown in FIGS. 18-22.

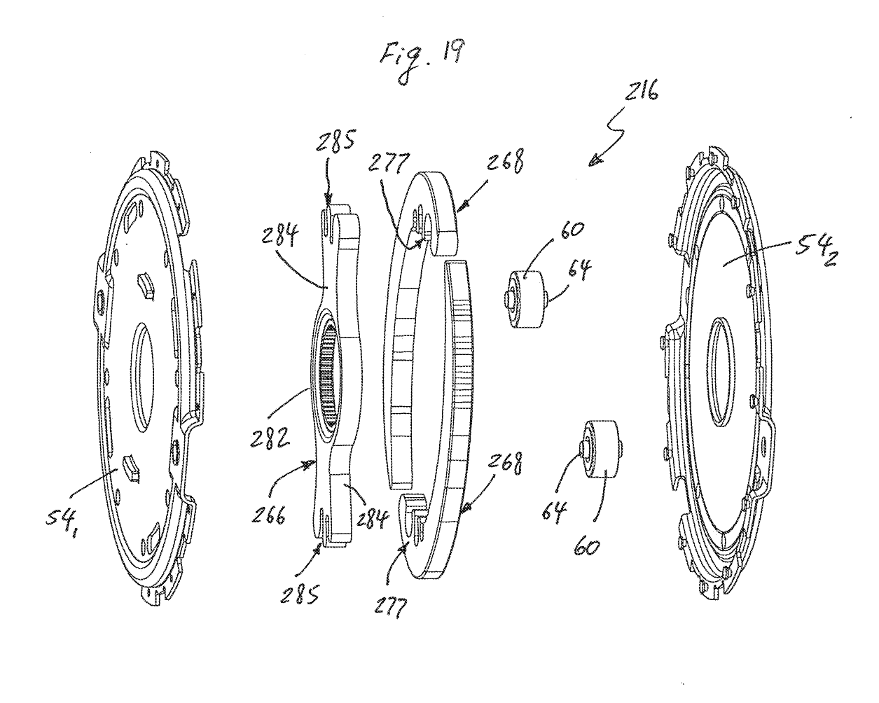

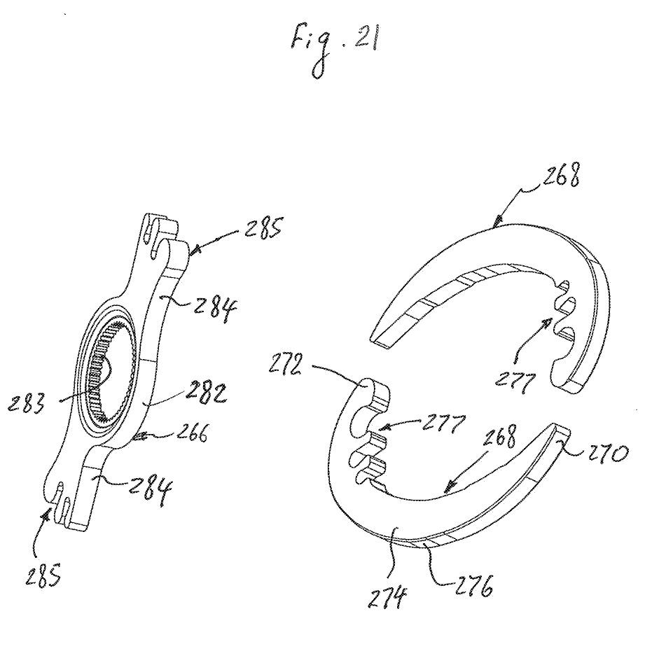

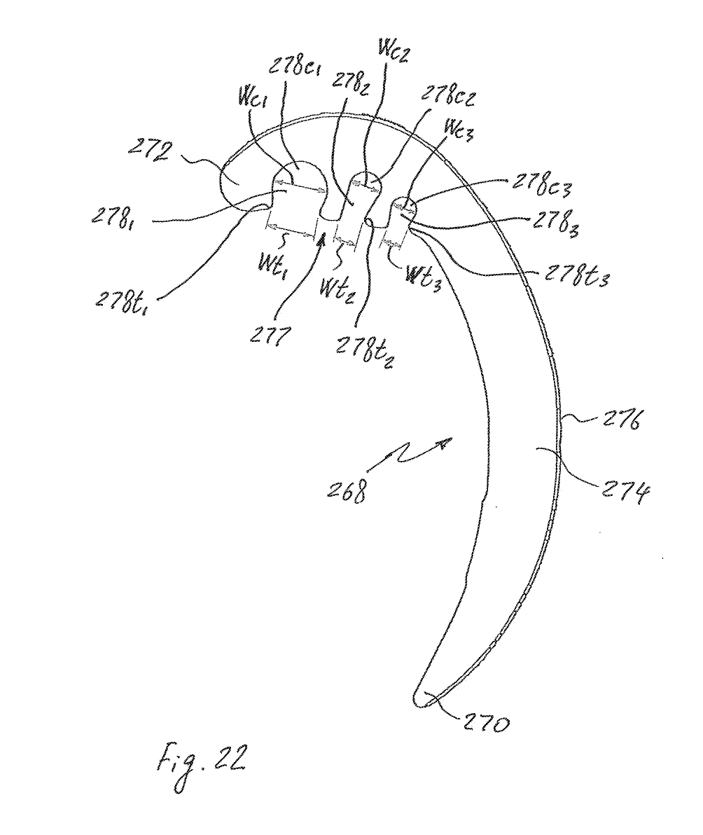

As shown in FIGS. 19, 21 and 22, each of the curved elastic blades 268 also has a connecting portion 277 non-rotatably connected to the central part 266 of the radially elastic member 252. The connecting portion 277 is preferably disposed between the proximal end 272 and the curved raceway portions 274 of the curved elastic blade 268, as best shown in FIGS. 20B and 21. The connecting portion 277 of the curved elastic blade 268 includes an engaging socket defined by at least two, preferably three radially and axially extending connecting channels 278₁, 278₂ and 278₃, best shown in FIG. 22. Preferably, each of the connecting channels 278₁, 278₂ and 278₃ has a non-circular cross-section in axial direction, i.e., in the direction of the rotational axis X. Preferably, as best shown in FIG. 22, the connecting channels 278₁, 278₂ and 278₃ are geometrically (dimensionally) different from each other. Alternatively, the connecting channels 278₁, 278₂ and 278₃ may be geometrically identical. Moreover, each of the connecting channels 278₁, 278₂ and 278₃ has an open throat 278t₁, 278t₂ or 278t₃ and an engaging cavity 278c₁, 278c₂ or 278c₃, as best shown in FIG. 22. As best shown in FIGS. 18, 19 and 21, each of the curved elastic blades 268 has a uniform thickness in the axial direction.

The central part 266 includes an annular central core member 282 coaxial with the rotational axis X, and at least one, preferably two substantially identical mounting arm members 284 extending radially outwardly from the central core member 280. A radially inner surface of the central core member 282 includes internal splines 283 for directly and non-rotatably engaging the complementary external splines 39 of the output hub 32. The central part 266 is formed integrally with the central core member 282 and the mounting arm members 284, such as a single part made, for example, by press-forming one-piece metal sheets, or a part made of separate components fixedly (i.e., non-moveably) connected together. Each of the mounting arm members 284 is non-moveably connected to the connecting portion 277 of one of the curved elastic blades 268.

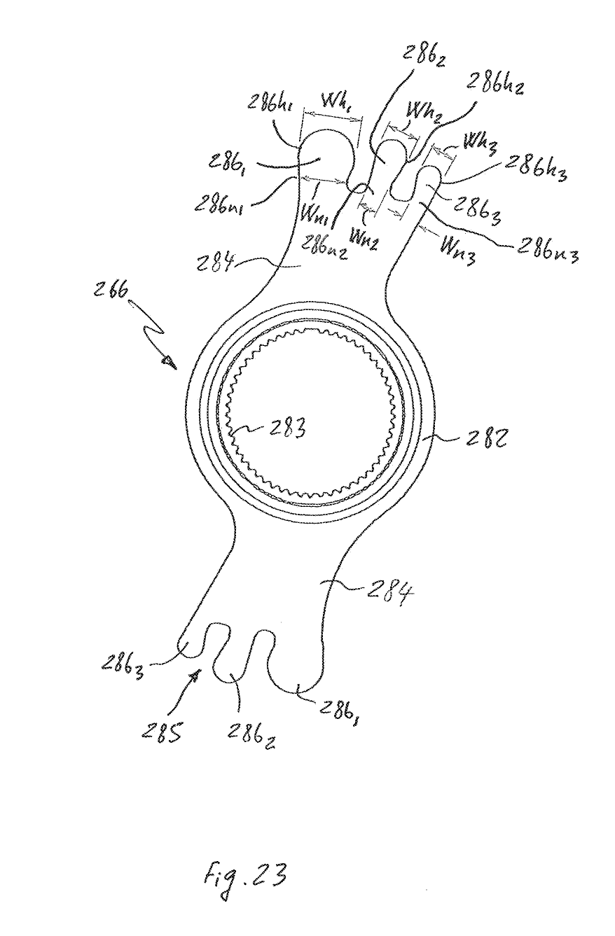

As shown in FIGS. 19, 21 and 23, a radially distal end of each of the mounting arm members 284 has a mounting portion 285 configured to non-rotatably engage the connecting portion 277 of the elastic blade 268 to the central part 266 of the elastic member 252. According to the third exemplary embodiment of the present invention, the mounting portion 285 of each of the mounting arm members 284 of the central part 266 includes a connection link defined by at least two, preferably three radially extending finger-shaped protrusions 286₁, 286₂ and 286₃, as best shown in FIG. 23. Preferably, each of the finger-shaped protrusions 286₁, 286₂ and 286₃ has a non-circular cross-section in axial direction, i.e., in the direction of the rotational axis X. Preferably, as best shown in FIG. 23, the finger-shaped protrusions 286₁, 286₂ and 286₃ are geometrically (dimensionally) different from each other. Alternatively, the finger-shaped protrusions 286₁, 286₂ and 286₃ may be geometrically identical.

The finger-shaped protrusions 286₁, 286₂ and 286₃ extend radially from the mounting arm members 284 of the central part 266. Each of the finger-shaped protrusions 286₁, 286₂ and 286₃ of the mounting portion 285 has a shape at least partially geometrically complementary to the shape of the corresponding one of the connecting channels 278₁, 278₂ and 278₃ of the associated curved elastic blade 268. Moreover, each of the finger-shaped protrusions 286₁, 286₂ and 286₃ has a neck portion 286n₁, 286n₂ or 286n₃ and a head portion 286h₁, 286h₂ or 286h₃, as best shown in FIG. 23. As best shown in FIGS. 18, 19 and 21, each of the mounting arm members 284 of the central part 266 has a uniform thickness in the axial direction.

It should be understood that the location on the elastic blade 268 furthest from the distal end 270 bears the most torque load. Accordingly, the finger-shaped protrusion 286₁ farthest from the distal end 270 should be the strongest, thus the largest. Thus, preferably, as best shown in FIG. 23, the finger-shaped protrusion 286₁ engaging the connecting channel 278₁ adjacent (or closest) to the proximal end 272 of the elastic blade 268 is the largest (i.e., has the cross-section in the radial direction larger than the cross-sections of the finger-shaped protrusions 286₂ and 286₃). The finger-shaped protrusion 286₃ farthest from the largest finger-shaped protrusion 286₁ is the smallest (i.e., has the cross-section in the radial direction smaller than the cross-sections of the finger-shaped protrusions 286₁ and 286₂). Similarly, preferably, as best shown in FIG. 22, the connecting channel 278₁ adjacent (or closest) to the proximal end 272 of the elastic blade 268 is the largest (i.e., has the cross-section in the radial direction larger than the cross-sections of the connecting channels 278₂ and 278₃). The connecting channel 278₃ farthest from the proximal end 272 of the elastic blade 268 is the smallest (i.e., has the cross-section in the radial direction smaller than the cross-sections of the connecting channels 278₁ and 278₂).

As best shown in FIG. 22, a width Wc₁, Wc₂ and Wc₃ of each of the engaging cavities 278c₁, 278c₂ and 278c₃, respectively, is larger than a width Wt₁, Wt₂ and Wt₃ of the open throat 278t₁, 278t₂ and 278t₃, respectively, of the connecting channels 278₁, 278₂ and 278₃. On the other hand, as best shown in FIG. 23, a width of the head portion 286h₁, 286h₂ and 286h₃ is larger than a width of the neck portion 286n₁, 286n₂ and 286n₃ of each of the finger-shaped protrusions 286₁, 286₂ and 286₃. Consequently, the finger-shaped protrusions 286₁, 286₂ and 286₃ of the central part 266 are coupled to the complementary connecting channels 278₁, 278₂ and 278₃ of the curved elastic blade 268 by axially sliding the finger-shaped protrusions 286₁, 286₂ and 286₃ into the corresponding connecting channels 278₁, 278₂ and 278₃, or vice versa. In addition, the head portions 286h₁, 286h₂ and 286h₃ of the finger-shaped protrusions 286₁, 286₂ and 286₃ have shapes geometrically complementary to shapes of the corresponding engaging cavity 278c₁, 278c₂ or 278c₃ of the connecting channels 278₁, 278₂ and 278₃. Similarly, the neck portions 286n₁, 286n₂ and 286n₃ of the finger-shaped protrusions 286₁, 286₂ and 286₃ have shapes at least partially geometrically complementary to shapes of the open throats 278t₁, 278t₂ and 278t₃ of the connecting channels 278₁, 278₂ and 278₃. Thus, the connecting channels 278₁, 278₂ and 278₃ of the connecting portion 277 of the curved elastic blade 268 are configured to receive the complementary finger-shaped protrusions 286₁, 286₂ and 286₃ of the mounting portion 285 to prevent the radial, axial and angular movement of the connecting portion 277 of the curved elastic blade 268 relative to the mounting arm members 284 of the central part 266. In other words, the finger-shaped protrusions 286₁, 286₂ and 286₃ are slidably received in and mate with the complementary connecting channels 278₁, 278₂ and 278₃ of the curved elastic blade 268 to provide a secure connection and prevent relative motion in the rotational and radial directions between the curved elastic blade 268 and the central part 266 of the radially elastic member 252. Consequently, torque is transferred from the curved elastic blade 268 to the output hub 32 through the central part 266 of the radially elastic member 252. Moreover, the curved elastic blades 268 and the mounting arm members 284 of the central part 266 are axially displaceable relative to each other.

A method for assembling the hydrokinetic torque-coupling device 210 is as follows. First, the impeller wheel 20, the turbine wheel 22, the stator 24, and the damper assembly 16 may each be preassembled. The impeller wheel 20, the turbine wheel 22 and the stator 24 subassemblies are assembled together to form the torque converter 14. Next, the turbine shell 28 of the turbine wheel 22 is non-movably (i.e., fixedly) secured to the flange 36 of the output hub 32 by the rivets 37 (best shown in FIG. 3) or by any other appropriate means, such as welding.

The torsional vibration damper 216 is then added. First, the central part 266, and the at least one, preferably two substantially identical, radially opposite curved elastic blades 268 of the radially elastic member 252 are formed separately from one another. Each of the elastic blades 268 is formed with the connecting portion 277 including the radially and axially extending connecting channels 278₁, 278₂ and 278₃. The mounting portion 285 of each of the mounting arm members 284 of the central part 266 includes a connecting link in the form of finger-shaped protrusions 286₁, 286₂ and 286₃. The finger-shaped protrusions 286₁, 286₂ and 286₃ of the mounting portion 285 have shapes at least partially geometrically complementary to a shape of the connecting channels 278₁, 278₂ and 278₃ of the curved elastic blade 268. Each of the mounting arm members 284 of the central part 266 is formed with the finger-shaped protrusions 286₁, 286₂ and 286₃ having shapes geometrically complementary to the shapes of the connecting channels 278₁, 278₂ and 278₃ of the curved elastic blade 268. Each of the central part 266 and the elastic blades 268 is made as an integral (or unitary) component, e.g., made as a single part, but may be made of separate components fixedly connected together. The central part 266 of the radially elastic member 252 is preferably made of metal, such as steel, subjected to metal treatment, such as quench, tempering, shot peening, to have core hardness 38-52 HRC. The curved elastic blades 268 are preferably made of metal, such as steel, subjected to metal treatment, such as induction hardening and stress relieving, to have core hardness 44-60 HRC. Thus, the central part 266 and the curved elastic blades 268 are made of materials having different chemical composition and/or mechanical properties. Thus, the second material of the curved elastic blade 268 has higher hardness than the first material of the central part 266.

Next, the connecting portion 277 of each of the elastic blades 268 is non-rotatably secured to the mounting portion 285 of one of the opposite mounting arm members 284. Specifically, the finger-shaped protrusions 286₁, 286₂ and 286₃ of the mounting portion 285 of each of the mounting arm members 284 of the central part 266 are axially slidably inserted into the complementary connecting channels 278₁, 278₂ and 278₃ of the connecting portion 277 of one of the curved elastic blade 268. As a result, the connection portion 277 of each of the elastic blades 268 is non-rotatably connected to one of the opposite mounting arm members 284 of the central part 266 so as to define the elastic member 252, as best shown in FIGS. 18, 20A and 20B.

Then, the torsional vibration damper 216 is assembled by placing the assembled radially elastic member 252 between the first and second side plates 54₁ and 54₂ of the torque input member 50. Then, the first and second side plates 54₁ and 54₂ are non-movably (i.e., fixedly) secured (connected) to one another so that the outer mounting flanges 56₁, 56₂ of the first and second side plates 54₁, 54₂ axially engage one another and are fixed by the rivets 57 extending through holes in the outer mounting flanges 56₁, 56₂ of the first and second side plates 54₁, 54₂, as best shown in FIG. 4.

Next, the torsional vibration damper 216 is slidably mounted to the output hub 32 by axially sliding the splines 283 of the core member 266 of the radially elastic member 252 over the complementary splines 39 of the output hub 32 for directly and non-rotatably engaging the output hub 32 with the radially elastic member 252 of the torsional vibration damper 16, as best shown in FIG. 3A.

Then, the locking piston 40 is axially displaced toward the torque input member 50 of the torsional vibration damper 216 such that each of the coupling lugs 48 positively engages one of the notches 59n of the torque input member 50 so as to non-rotatably couple the locking piston 40 and the torque input member 50 while allowing an axial motion of the locking piston 40 with respect to the torque input member 50, as best shown in FIGS. 3A and 3B. At the same time, the locking piston 40 is mounted to the output hub 32 so that the cylindrical rim 46 of the locking piston 40 is disposed in the annular groove 38 of the output hub 32, as shown in FIGS. 3A and 3B.

Next, the first shell 17₁ and the second shell 17₂ are non-movably (i.e., fixedly) connected and sealed together about their outer peripheries, such as by a weld 19, as shown in FIG. 2. After that, the hydrokinetic torque-coupling device 210 is mounted to the transmission input shaft so that the output hub 32 is splined directly to the transmission input shaft 2b.

In a hydrokinetic torque-coupling device 310 of a fourth exemplary embodiment illustrated in FIGS. 2-4 and 24-29, the torsional vibration damper 216 is replaced by a torsional vibration damper 316. The hydrokinetic torque-coupling device 310 of FIGS. 2-4 and 24-29 corresponds substantially to the hydrokinetic torque-coupling device 210 of FIGS. 2-4 and 18-23, and the torsional vibration damper 316, which primarily differs, will therefore be explained in detail below.

The torsional vibration damper 316 comprises a torque input member 50 rotatable about the rotational axis X, and an radially elastic member 352 rotatable relative to the torque input member 50 around the rotational axis X and elastically coupled to the torque input member 50. The radially elastic member 352 is non-rotatably coupled to the output hub 32. Accordingly, the radially elastic member 352 elastically couples the output hub 32 to the torque input member 50, as best shown in FIGS. 2 and 3.

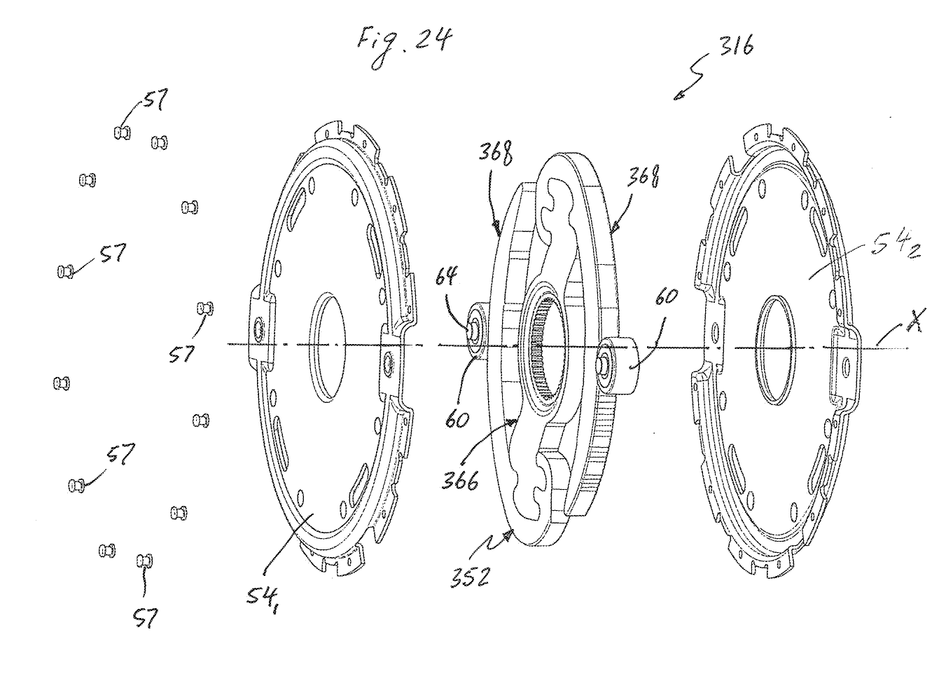

The radially elastic member 352 includes a central part 366 coaxial with the rotational axis X and rotatable relative the torque input member 50, and at least one, preferably two substantially identical, radially opposite curved elastic blades (or leaves) 368 formed separately from one another and the central part 366, as best shown in FIGS. 24, 25 and 27. The radially elastic member 352 is configured to be elastically and radially supported by the rolling bodies 60 and to elastically bend (or deform) in the radial direction upon rotation of the torque input member 50 with respect to the radially elastic member 352. The central part 366 is configured to non-rotatably couple the output hub 32. At the same time, the central part 366 of the radially elastic member 352 is axially moveable relative to the output hub 32 due to a splined connection therebetween. Accordingly, the radially elastic member 352 is non-rotatably coupled to the output hub 32.

As best shown in FIGS. 2, 3A, 24 and 26B, each of the curved elastic blades 368 is symmetrical with respect to the rotational axis X. Moreover, each of the curved elastic blades 368 has a free distal (or first) end 370, a proximal (or second) end 372, and a curved raceway portion 374 disposed between the free distal end 370 and the proximal end 372 of the elastic blades 368 for bearing one of the rolling bodies 60.

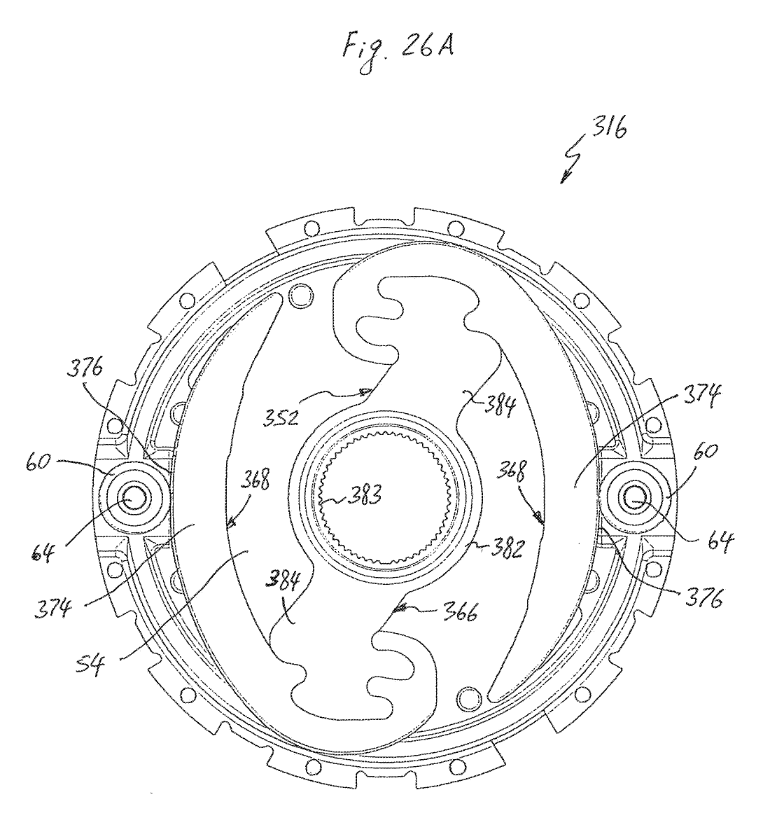

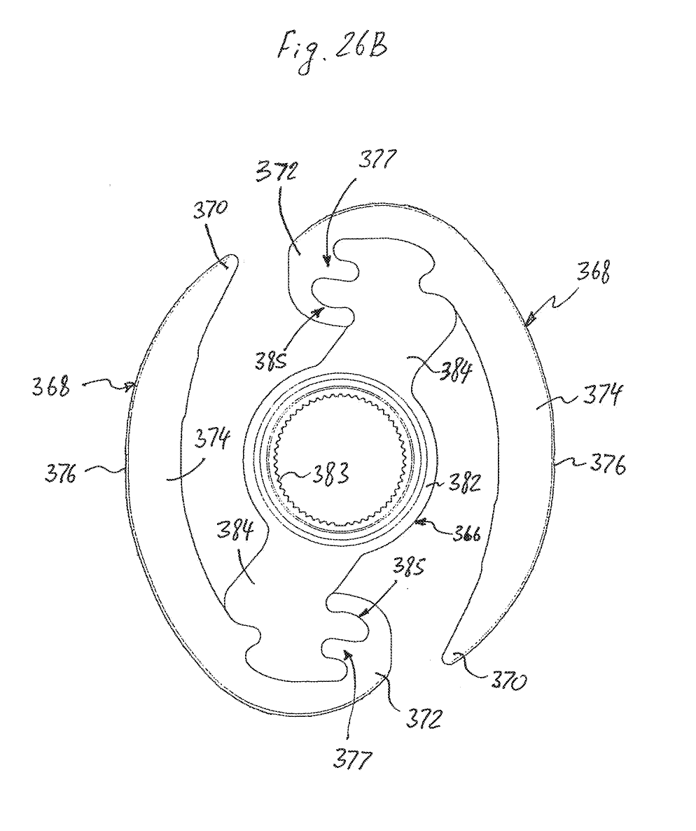

Each of the curved elastic blades 368 is radially elastically deformable relative to the central part 366. A radially external surface of the curved raceway portion 374 of each of elastic blade 368 defines a radially outer raceway 376 configured as a surface that is in a rolling contact with one of the rolling bodies 60, so that each of the rolling bodies 60 is positioned radially outside of the elastic blade 368, as illustrated in FIGS. 24 and 26A. The raceway 376 of the curved raceway portion 374 of each curved elastic blade 368 extends on a circumference with an angle ranging from about 120° to about 180°. The raceway 376 of each of the curved raceway portions 374 has a generally convex shape, as best shown in FIGS. 24, 26B, 27 and 28.

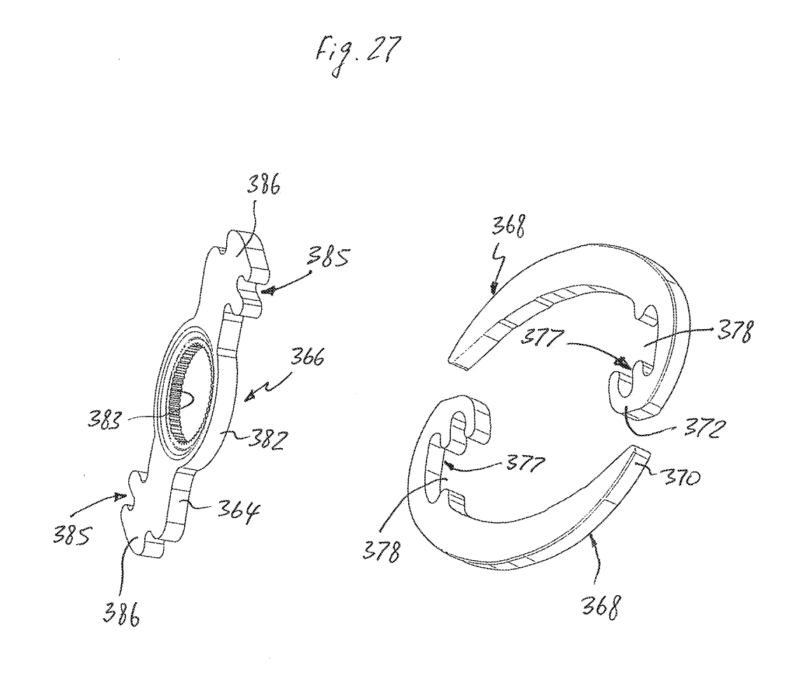

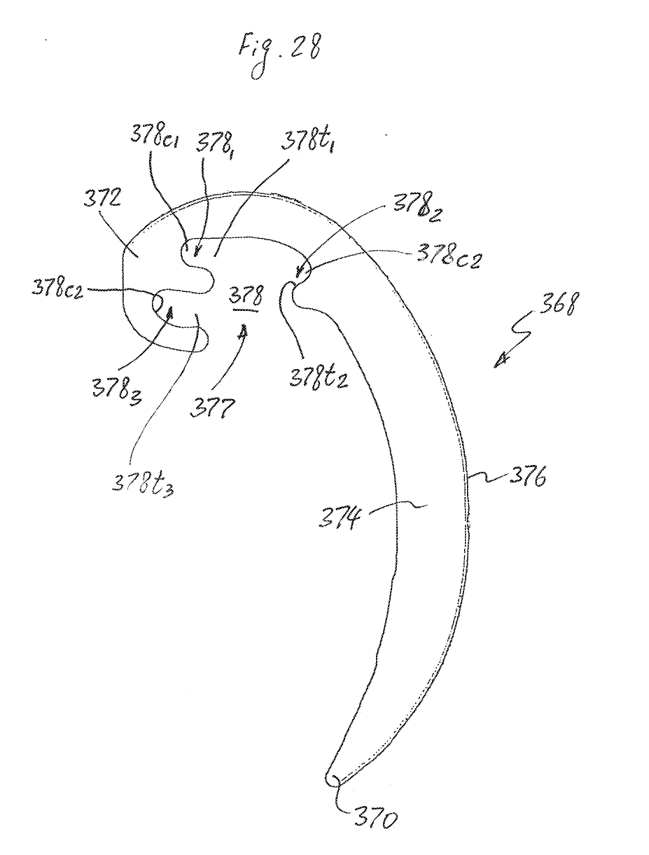

As shown in FIGS. 26B, 27 and 28, each of the curved elastic blades 368 also has a connecting portion 377 non-rotatably connected to the central part 366 of the radially elastic member 352. The connecting portion 377 is preferably disposed between the proximal end 372 and the curved raceway portions 374 of the curved elastic blade 368, as best shown in FIGS. 26B and 28. The connecting portion 377 of the curved elastic blade 368 is defined by an axially extending engaging socket 378, as best shown in FIGS. 27 and 28. Preferably, the engaging socket 378 has a non-circular cross-section in axial direction, i.e., in the direction of the rotational axis X. The engaging socket 378 of the connecting portion 377 of the curved elastic blade 368 includes at least two, preferably three connecting channels 378₁, 378₂ and 378₃ extending generally angularly and axially, as best shown in FIG. 28. Preferably, each of the connecting channels 378₁, 378₂ and 378₃ has a non-circular cross-section in the axial direction, i.e., in the direction of the rotational axis X. Preferably, as best shown in FIG. 28, the connecting channels 378₁, 378₂ and 378₃ are geometrically (dimensionally) different from each other. Alternatively, the connecting channels 378₁, 378₂ and 378₃ may be geometrically identical. Moreover, each of the connecting channels 378₁, 378₂ and 378₃ has an open throat 378t₁, 378t₂ and 378t₃, and an engaging cavity 378c₁, 378c₂ and 378c₃, respectively, as best shown in FIG. 28. As best shown in FIG. 27, each of the curved elastic blades 368 has a uniform thickness in the axial direction.

Preferably, as best shown in FIG. 28, the connecting channel 378₃ adjacent (or closest) to the proximal end 372 of the elastic blade 368 is the largest (i.e., has the cross-section in the radial direction larger than the cross-sections of the connecting channels 378₁ and 378₂). The connecting channel 378₂ farthest from the proximal end 372 of the elastic blade 368 is the smallest (i.e., has the cross-section in the radial direction smaller than the cross-sections of the connecting channels 378₁ and 378₃).

The central part 366 includes an annular central core member 382 coaxial with the rotational axis X, and at least one, preferably two substantially identical mounting arm members 384 extending radially outwardly from the central core member 380. A radially inner surface of the central core member 382 includes internal splines 383 for directly and non-rotatably engaging the complementary external splines 39 of the output hub 32. The central part 366 is preferably formed integrally with the central core member 382 and the mounting arm members 384, such as a single part made, for example, by press-forming one-piece metal sheets, or a part made of separate components fixedly (i.e., non-moveably) connected together. Each of the mounting arm members 384 is non-moveably connected to the connecting portion 377 of one of the curved elastic blades 368, as best shown in FIG. 26B.

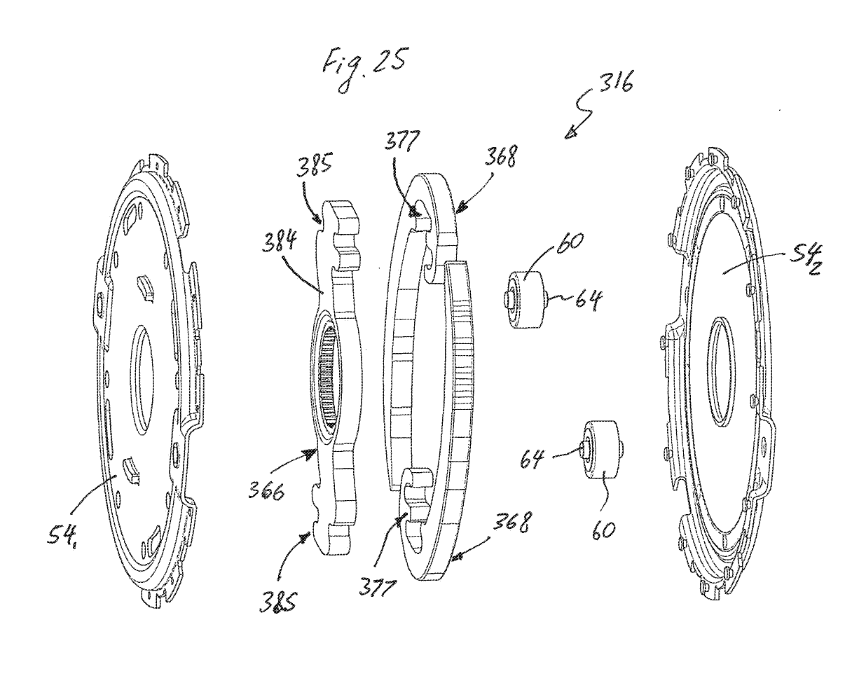

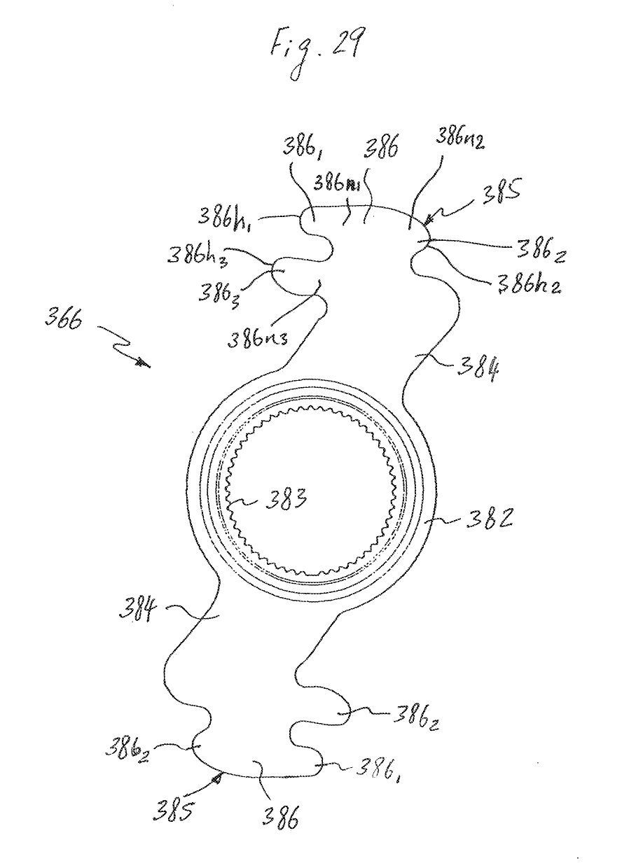

As shown in FIGS. 25, 26B, 27 and 29, a radially distal end of each of the mounting arm members 384 has a mounting portion 385 configured to non-rotatably engage the connecting portion 377 of the elastic blade 368 to the central part 366 of the elastic member 352. According to the fourth exemplary embodiment of the present invention, the mounting portion 385 of each of the mounting arm members 384 of the central part 366 includes a connection link 386 including at least two, preferably three generally angularly extending finger-shaped protrusions 386₁, 386₂ and 386₃, best shown in FIG. 29. The finger-shaped protrusions 386₁, 386₂ and 386₃ extend radially from the mounting arm members 384 of the central part 366. Preferably, each of the finger-shaped protrusions 386₁, 386₂ and 386₃ has a non-circular cross-section in the axial direction, i.e., in the direction of the rotational axis X. Preferably, as best shown in FIG. 29, the finger-shaped protrusions 386₁, 386₂ and 386₃ are geometrically (dimensionally) different from each other. Alternatively, the finger-shaped protrusions 386₁, 386₂ and 386₃ may be geometrically identical.

The connection link 386 of the mounting portion 385 has a shape at least partially geometrically complementary to a shape of the engaging socket 378 of the connecting portion 377 of the curved elastic blade 368. Accordingly, each of the finger-shaped protrusions 386₁, 386₂ and 386₃ of the connection link 386 has a shape at least partially geometrically complementary to a shape of the corresponding one of the connecting channels 378₁, 378₂ and 378₃ of the curved elastic blade 368.

The connecting channels 378₁, 378₂ and 378₃ of the engaging socket 378 of the connecting portion 377 of the curved elastic blade 368 are configured to receive the complementary finger-shaped protrusions 386₁, 386₂ and 386₃ of the connection link 386 of the mounting portion 385 to prevent the radial, axial and angular movement of the connecting portion 377 of the curved elastic blade 368 relative to the mounting arm members 384 of the central part 366. In other words, the connecting link 386 is slidably received in and mates with the complementary engaging socket 378 of the curved elastic blade 368 to provide a secure connection and prevent relative motion in the rotational and radial directions between the curved elastic blade 368 and the central part 366 of the radially elastic member 352. Accordingly, the finger-shaped protrusions 386₁, 386₂ and 386₃ are also slidably received in and mate with the complementary connecting channels 378₁, 378₂ and 378₃ of the curved elastic blade 368 to provide a secure connection and prevent relative motion in the rotational and radial directions between the curved elastic blade 368 and the central part 366 of the radially elastic member 352. Consequently, torque is transferred from the curved elastic blade 368 to the output hub 32 through the central part 366 of the radially elastic member 352. Moreover, the curved elastic blades 368 and the mounting arm members 384 of the central part 366 are axially displaceable relative to each other.

The finger-shaped protrusions 386₁, 386₂ and 386₃ of the connection link 386 extend radially from the mounting arm members 384 of the central part 266. The connection link 386 has a shape at least partially geometrically complementary to a shape of the corresponding engaging socket 378 of the curved elastic blade 368. Accordingly, each of the finger-shaped protrusions 386₁, 386₂ and 386₃ of the connection link 386 has a shape at least partially geometrically complementary to a shape of the corresponding one of the connecting channels 378₁, 378₂ and 378₃ of the engaging socket 378 of the connecting portion 377 of the curved elastic blade 368. Moreover, each of the finger-shaped protrusions 386₁, 386₂ and 386₃ has a neck portion 386n₁, 386n₂ or 386n₃ and a head portion 386h₁, 386h₂ or 386h₃, as best shown in FIG. 29. As best shown in FIGS. 24, 25 and 27, each of the mounting arm members 384 of the central part 366 has a uniform thickness in the axial direction.

It should be understood that the location on the elastic blade 368 furthest from the distal end 370 bears the most torque load. Accordingly, the finger-shaped protrusion 386₃ farthest from the distal end 370 should be the strongest, thus the largest. Thus, preferably, as best shown in FIG. 29, the finger-shaped protrusion 386₃ engaging the connecting channel 378₃ adjacent (or closest) to the proximal end 372 of the elastic blade 368 is the largest (i.e., has the cross-section in the radial direction larger than the cross-sections of the finger-shaped protrusions 386₁ and 386₂). The finger-shaped protrusion 386₂ farthest from the largest finger-shaped protrusion 386₃ is the smallest (i.e., has the cross-section in the radial direction smaller than the cross-sections of the finger-shaped protrusions 386₁ and 386₃).

Consequently, the finger-shaped protrusions 386₁, 386₂ and 386₃ of the connection link 386 of the central part 366 are coupled to the complementary connecting channels 378₁, 378₂ and 378₃ of the engaging socket 378 of the curved elastic blade 368 by axially sliding the finger-shaped protrusions 286₁, 286₂ and 286₃ into the corresponding engaging sockets 386₁, 386₂ and 386₃, or vice versa. In addition, the head portions 386h₁, 386h₂ or 386h₃ of the finger-shaped protrusions 386₁, 386₂ and 386₃ have shapes geometrically complementary to shapes of the corresponding engaging cavities 378c₁, 378c₂ and 378c₃ of the connecting channels 378₁, 378₂ and 378₃. Similarly, the neck portions 386n₁, 386n₂ and 386n₃ of the finger-shaped protrusions 386₁, 386₂ and 386₃ have shapes at least partially geometrically complementary to shapes of the open throats 378t₁, 378t₂ and 378t₃ of the connecting channels 378₁, 378₂ and 378₃. Thus, the engaging socket 378 of the connecting portion 377 of the curved elastic blade 368 is configured to receive the complementary connection link 386 of the mounting portion 385 to prevent the radial, axial and angular movement of the connecting portion 377 of the curved elastic blade 368 relative to the connection link 386 of the mounting arm members 384 of the central part 366. The finger-shaped protrusions 386₁, 386₂ and 386₃ are slidably received in and mate with the complementary connecting channels 378₁, 378₂ and 378₃ of the curved elastic blade 368 to provide a secure connection and prevent relative motion in the rotational and radial directions between the curved elastic blade 368 and the central part 366 of the radially elastic member 352. Consequently, torque is transferred from the curved elastic blade 368 to the output hub 32 through the central part 366 of the radially elastic member 352. Moreover, the curved elastic blades 368 and the mounting arm members 384 of the central part 366 are axially displaceable relative to each other.

A method for assembling the hydrokinetic torque-coupling device 310 is as follows. First, the impeller wheel 20, the turbine wheel 22, the stator 24, and the damper assembly 16 may each be preassembled. The impeller wheel 20, the turbine wheel 22 and the stator 24 subassemblies are assembled together to form the torque converter 14. Next, the turbine shell 28 of the turbine wheel 22 is non-movably (i.e., fixedly) secured to the flange 36 of the output hub 32 by the rivets 37 (best shown in FIG. 3) or by any other appropriate means, such as welding.

The torsional vibration damper 316 is then added. First, the central part 366, and the at least one, preferably two substantially identical, radially opposite curved elastic blades 368 of the radially elastic member 352 are formed separately from one another. Each of the elastic blades 368 is formed with the connecting portion 377 including the axially extending engaging socket 378. In turn, the engaging socket 378 has angularly and axially extending connecting channels 378₁, 378₂ and 378₃. The mounting portion 385 of each of the mounting arm members 384 of the central part 366 includes a connecting link 386 having finger-shaped protrusions 386₁, 386₂ and 386₃. The finger-shaped protrusions 386₁, 386₂ and 386₃ of the connecting link 386 have shapes at least partially geometrically complementary to a shape of the connecting channels 378₁, 378₂ and 378₃ of the engaging socket 378 of the curved elastic blade 368. Each of the mounting arm members 384 of the central part 366 is formed with the connecting link 386 and the finger-shaped protrusions 386₁, 386₂ and 386₃ having shapes geometrically complementary to the shapes of the engaging socket 378 and the connecting channels 378₁, 378₂ and 378₃ of the curved elastic blade 368. Each of the central part 366 and the elastic blades 368 is made as an integral (or unitary) component, e.g., made as a single part, but may be made of separate components fixedly connected together. The central part 366 of the radially elastic member 352 is preferably made of metal, such as steel, subjected to metal treatment, such as quench, tempering, shot peening, to have core hardness 38-52 HRC. The curved elastic blades 368 are preferably made of metal, such as steel, subjected to metal treatment, such as induction hardening and stress relieving, to have core hardness 44-60 HRC. Thus, the central part 366 and the curved elastic blades 368 are made of materials having different chemical composition and/or mechanical properties. Thus, the second material of the curved elastic blade 368 has higher hardness than the first material of the central part 366.

Next, the connecting portion 377 of each of the elastic blades 368 is non-rotatably secured to the mounting portion 385 of one of the opposite mounting arm members 384. Specifically, the connection link 386 of each of the mounting arm members 384 of the central part 366 is axially slidably inserted into the complementary engaging socket 378 of the connecting portion 377 of one of the curved elastic blade 368. Accordingly, the finger-shaped protrusions 386₁, 386₂ and 386₃ of the connection link 386 of each of the mounting arm members 384 of the central part 366 are axially slidably inserted into the complementary connecting channels 378₁, 378₂ and 378₃ of the engaging socket 378 of the connecting portion 377 of one of the curved elastic blade 368. As a result, the connection portion 377 of each of the elastic blades 368 is non-rotatably connected to one of the opposite mounting arm members 384 of the central part 366 so as to define the elastic member 352, as best shown in FIGS. 24, 26A and 26B.

Then, the torsional vibration damper 316 is assembled by placing the assembled radially elastic member 352 between the first and second side plates 54₁ and 54₂ of the torque input member 50. Then, the first and second side plates 54₁ and 54₂ are non-movably (i.e., fixedly) secured (connected) to one another so that the outer mounting flanges 56₁, 56₂ of the first and second side plates 54₁, 54₂ axially engage one another and are fixed by the rivets 57 extending through holes in the outer mounting flanges 56₁, 56₂ of the first and second side plates 54₁, 54₂, as best shown in FIG. 4.

Next, the torsional vibration damper 316 is slidably mounted to the output hub 32 by axially sliding the splines 383 of the core member 366 of the radially elastic member 352 over the complementary splines 39 of the output hub 32 for directly and non-rotatably engaging the output hub 32 with the radially elastic member 352 of the torsional vibration damper 16, as best shown in FIG. 3A.

Then, the locking piston 40 is axially displaced toward the torque input member 50 of the torsional vibration damper 316 such that each of the coupling lugs 48 positively engages one of the notches 59n of the torque input member 50 so as to non-rotatably couple the locking piston 40 and the torque input member 50 while allowing an axial motion of the locking piston 40 with respect to the torque input member 50, as best shown in FIGS. 3A and 3B. At the same time, the locking piston 40 is mounted to the output hub 32 so that the cylindrical rim 46 of the locking piston 40 is disposed in the annular groove 38 of the output hub 32, as shown in FIGS. 3A and 3B.

Next, the first shell 17₁ and the second shell 17₂ are non-movably (i.e., fixedly) connected and sealed together about their outer peripheries, such as by a weld 19, as shown in FIG. 2. After that, the hydrokinetic torque-coupling device 310 is mounted to the transmission input shaft so that the output hub 32 is splined directly to the transmission input shaft 2b.

The foregoing description of the exemplary embodiments of the present invention has been presented for the purpose of illustration in accordance with the provisions of the Patent Statutes. It is not intended to be exhaustive or to limit the invention to the precise forms disclosed. The embodiments disclosed hereinabove were chosen in order to best illustrate the principles of the present invention and its practical application to thereby enable those of ordinary skill in the art to best utilize the invention in various embodiments and with various modifications as suited to the particular use contemplated, as long as the principles described herein are followed. This application is therefore intended to cover any variations, uses, or adaptations of the invention using its general principles. Further, this application is intended to cover such departures from the present disclosure as come within known or customary practice in the art to which this invention pertains. Thus, changes can be made in the above-described invention without departing from the intent and scope thereof. It is also intended that the scope of the present invention be defined by the claims appended thereto.

1. A torsional vibration damper of a hydrokinetic torque-coupling device for coupling a driving shaft and a driven shaft together, comprising:
a torque input member including a radially oriented first side plate and at least one supporting member mounted to the first side plate; and
a radially elastic member elastically coupled to the torque input member;
the radially elastic member including a central part and at least one curved elastic blade formed separately from the central part;
the central part being coaxial with the rotational axis and rotatable relative the torque input member, the central part having a mounting portion;
the at least one curved elastic blade having a connection portion, a free distal end and a curved raceway portion disposed between the connection portion and the free distal end of the at least one elastic blade for bearing the at least one supporting member;
the connection portion of the at least one curved elastic blade non-rotatably connected to the mounting portion of the central part;
the curved raceway portion of the at least one curved elastic blade configured to elastically and radially engage the at least one supporting member and to elastically bend in the radial direction upon rotation of the torque input member with respect to the radially elastic member.

2. The torsional vibration damper as defined in claim 1, wherein the connection portion of the at least one curved elastic blade is geometrically complementary to the mounting portion of the central part.

3. The torsional vibration damper as defined in claim 1, further comprising a radially oriented second side plate axially spaced from and non-rotatably attached to the first side plate so that the at least one supporting member and the radially elastic member are disposed between the first and second side plates, and wherein the radially elastic member is pivotable relative to the first and second side plates and elastically coupled to the at least one supporting member.

4. The torsional vibration damper as defined in claim 1, wherein the connection portion of the at least one curved elastic blade is disposed between the curved raceway portion and a proximal end of the at least one curved elastic blade, which is disposed angularly opposite to the free distal end thereof.

5. The torsional vibration damper as defined in claim 1, wherein the central part includes an annular central core member coaxial with the rotational axis, and at least one arm member extending radially outwardly from the central core member, and wherein the mounting portion is provided at a radially distal end of the at least one arm member.

6. The torsional vibration damper as defined in claim 1, wherein the connection portion includes a connecting link, wherein the mounting portion includes an engaging socket geometrically complementary to the connecting link of the connecting portion of the at least one curved elastic blade, and wherein the connecting link of the connection portion is non-rotatably mounted in the engaging socket of the mounting portion.

7. The torsional vibration damper as defined in claim 1, wherein the connection portion of the at least one curved elastic blade includes an engaging socket, wherein the mounting portion of the central part includes a connecting link geometrically complementary to the engaging socket, and wherein the connecting link of the mounting portion of the central part is non-rotatably mounted in the engaging socket of the connection portion of the at least one curved elastic blade.

8. The torsional vibration damper as defined in claim 7, wherein the engaging socket of the connection portion of the at least one curved elastic blade includes at least two radially extending connecting channels, wherein the connecting link of the mounting portion of the central part includes at least two radially extending finger-shaped protrusions each geometrically complementary to one of the connecting channels, and wherein the finger-shaped protrusions of the connecting link of the mounting portion of the central part are non-rotatably mounted in the connecting channels of the engaging socket of the connection portion of the at least one curved elastic blade.

9. The torsional vibration damper as defined in claim 9, wherein the radially extending connecting channel farthest from the free distal end of the elastic blade is the largest.

10. The torsional vibration damper as defined in claim 7, wherein the engaging socket of the connection portion of the at least one curved elastic blade includes at least two generally angularly extending engaging sockets, wherein the connecting link of the mounting portion of the central part includes at least two angularly extending finger-shaped protrusions each geometrically complementary to one of the connecting channels, and wherein the finger-shaped protrusions of the connecting link of the mounting portion of the central part are non-rotatably mounted in the connecting channels of the engaging socket of the connection portion of the at least one curved elastic blade.

11. The torsional vibration damper as defined in claim 10, wherein the angularly extending engaging socket farthest from the free distal end of the elastic blade is the largest.

12. The torsional vibration damper as defined in claim 1, wherein the central part is made of a first material having a first hardness and the at least one curved elastic blade is made of a second material having a second hardness different from the first hardness.

13. The torsional vibration damper as defined in claim 1, the torque input member includes two supporting members both mounted to the first side plate and disposed radially opposite from one another, wherein the radially elastic member includes two curved elastic blades disposed radially opposite from one another, and wherein the curved raceway portion of each of the curved elastic blades is configured to elastically and radially engage one of the supporting members and to elastically bend in the radial direction upon rotation of the torque input member with respect to the radially elastic members.

14. The torsional vibration damper as defined in claim 13, wherein the central part includes two arm members extending radially outwardly from the central core member, and wherein the mounting portions are provided at a radially distal end of one of the arm members.

15. The torsional vibration damper as defined in claim 1, wherein the at least one supporting member is an annular rolling body.

16. A hydrokinetic torque-coupling device for coupling a driving shaft and a driven shaft together, comprising:
a casing rotatable about a rotational axis and having a locking surface;
a torque converter including an impeller wheel rotatable about the rotational axis and a turbine wheel disposed in the casing coaxially with the rotational axis, the turbine wheel disposed axially opposite to the impeller wheel and hydro-dynamically rotationally drivable by the impeller wheel;
a lock-up clutch including a locking piston axially moveable along the rotational axis to and from the locking surface of the casing, the locking piston having an engagement surface configured to selectively frictionally engage the locking surface of the casing to position the hydrokinetic torque-coupling device into and out of a lockup mode in which the locking piston is mechanically frictionally locked to the casing so as to be non-rotatable relative to the casing; and
a torsional vibration damper comprising
a torque input member including a radially oriented first side plate and at least one supporting member mounted to the first side plate, the first side plate non-rotatably coupled to the locking piston; and
a radially elastic member elastically coupled to the torque input member;
the radially elastic member including a central part and at least one curved elastic blade formed separately from the central part;
the central part being coaxial with the rotational axis and rotatable relative the torque input member, the central part having a mounting portion;
the at least one curved elastic blade having a connection portion, a free distal end and a curved raceway portion disposed between the connection portion and the free distal end of the at least one elastic blade for bearing the at least one supporting member;
the connection portion of the at least one curved elastic blade non-rotatably connected to the mounting portion of the central part;
the curved raceway portion of the at least one curved elastic blade configured to elastically and radially engage the at least one supporting member and to elastically bend in the radial direction upon rotation of the torque input member with respect to the radially elastic member.

17. The torsional vibration damper as defined in claim 16, wherein the connection portion of the at least one curved elastic blade is geometrically complementary to the mounting portion of the central part.

18. The torsional vibration damper as defined in claim 16, further comprising a radially oriented second side plate axially spaced from and non-rotatably attached to the first side plate so that the at least one supporting member and the radially elastic member are disposed between the first and second side plates, and wherein the radially elastic member is pivotable relative to the first and second side plates and elastically coupled to the at least one supporting member.

19. The torsional vibration damper as defined in claim 16, wherein the central part is made of a first material having a first hardness and the at least one curved elastic blade is made of a second material having a second hardness different from the first hardness.

20. The torsional vibration damper as defined in claim 16, wherein the connection portion includes a connecting link, wherein the mounting portion includes an engaging socket geometrically complementary to the connecting link of the connecting portion of the at least one curved elastic blade, and wherein the connecting link of the connection portion is non-rotatably mounted in the engaging socket of the mounting portion.

21. The torsional vibration damper as defined in claim 16, wherein the connection portion of the at least one curved elastic blade includes an engaging socket, wherein the mounting portion of the central part includes a connecting link geometrically complementary to the engaging socket, and wherein the connecting link of the mounting portion of the central part is non-rotatably mounted in the engaging socket of the connection portion of the at least one curved elastic blade.

22. A method for assembling a torsional vibration damper of a hydrokinetic torque-coupling device for coupling a driving shaft and a driven shaft together, the method comprising the steps of:
providing a torque input member including a radially oriented first side plate and at least one supporting member mounted to the first side plate;
providing a radially elastic member including a central part and at least one curved elastic blade formed separately from the central part;
the central part having a mounting portion;
the at least one curved elastic blade having a connection portion, a free distal end and a curved raceway portion disposed between the connection portion and the free distal end of the at least one elastic blade;
non-rotatably connecting the connection portion of the at least one curved elastic blade to the mounting portion of the central part to define the radially elastic member;
mounting the assembled radially elastic member to the torque input member so that the curved raceway portion of the at least one curved elastic blade elastically and radially engages the at least one supporting member, the curved raceway portion of the at least one curved elastic blade configured to elastically bend in the radial direction upon rotation of the torque input member with respect to the radially elastic member.
